(19) United States
(12) Patent Application Publication
(10) Pub. No.: US 2022/0230104 A1
(43) Pub. Date: Jul. 21, 2022

(54) INFORMATION PROCESSING APPARATUS, INFORMATION PROCESSING METHOD, AND INFORMATION PROCESSING PROGRAM

(71) Applicant: Sony Group Corporation, Tokyo (JP)

(72) Inventor: Haruhiko KISHI, Tokyo (JP)

(73) Assignee: Sony Group Corporation, Tokyo (JP)

(21) Appl. No.: 17/615,096

(22) PCT Filed: Jun. 12, 2020
(86) PCT No.: PCT/JP2020/023139

§ 371 Date: Nov. 30, 2021

(30) Foreign Application Priority Data
Jul. 8, 2019 (JP) 2019-126931

(51) Int. Cl. G06Q 10/06; G10H 1/00

(52) U.S. Cl. CPC G06Q 10/067; G10H 1/0025; G06N 20/00; G10H 2250/015; G10H 2210/111

(57) ABSTRACT

An information processing apparatus according to the present disclosure includes a generation unit that generates a model regarding generation of content by using data provided by a user subject of a service regarding creation of the content, the user subject having one authority level among a plurality of authority levels of the service, and a determination unit that determines a usage mode of the model generated by the generation unit according to the one authority level of the user subject.

### FIELD

The present disclosure relates to an information processing apparatus, an information processing method, and an information processing program.

### BACKGROUND

With the advancement of artificial intelligence (AI), utilization of computers in the field of art has been advanced. For example, a technology is known in which machine learning is performed on existing music as learning data to generate a learning model for generating music, and a computer is caused to compose new music (for example, Patent Literature 1). In such a technology, it is possible to imitate features of the existing music or generate a more natural melody by using a Markov model.

### CITATION LIST

### Patent Literature

Patent Literature 1: U.S. Pat. No. 9,110,817

### SUMMARY

### Technical Problem

According to the conventional technology, since music data proposed (generated) by artificial intelligence (AI) can be used in composition work, a user can compose music on the basis of more various viewpoints.

However, in the above-described conventional technology, it is not always possible to appropriately determine a usage mode of a model used for generating content such as music. For example, in the above-described conventional technology, music is merely generated using a model such as a Markov model, and there is no consideration in what kind of user uses a model used for generating content such as music in what mode. Therefore, it is desired to appropriately determine the usage mode of the model used for generating the content such as music.

Therefore, the present disclosure proposes an information processing apparatus, an information processing method, and an information processing program capable of appropriately using the model according to data used for generating the model.

### Solution to Problem

According to the present disclosure, an information processing apparatus includes a generation unit that generates a model regarding generation of content by using data provided by a user subject of a service regarding creation of the content, the user subject having one authority level among a plurality of authority levels of the service; and a determination unit that determines a usage mode of the model generated by the generation unit according to the one authority level of the user subject.

### BRIEF DESCRIPTION OF DRAWINGS

FIG. 1 is a diagram illustrating an example of information processing according to an embodiment of the present disclosure.

FIG. 2 is a diagram illustrating a usage mode example of a model according to the embodiment of the present disclosure.

FIG. 3 is a diagram illustrating a usage mode example of the model according to the embodiment of the present disclosure.

FIG. 4 is a diagram illustrating a usage mode example of the model according to the embodiment of the present disclosure.

FIG. 5 is a diagram illustrating a usage mode example of the model according to the embodiment of the present disclosure.

FIG. 6 is a diagram illustrating a usage mode example of the model according to the embodiment of the present disclosure.

FIG. 7 is a diagram illustrating a configuration example of an information processing system according to the embodiment of the present disclosure.

FIG. 8 is a diagram illustrating a configuration example of an information processing apparatus according to the embodiment of the present disclosure.

FIG. 9 is a diagram illustrating an example of a user information storage unit according to the embodiment of the present disclosure.

FIG. 10 is a diagram illustrating an example of a work information storage unit according to the embodiment of the present disclosure.

FIG. 11 is a diagram illustrating an example of a learning model information storage unit according to the embodiment of the present disclosure.

FIG. 12 is a diagram illustrating an example of a sales management information storage unit according to the embodiment of the present disclosure.

FIG. 13 is a diagram illustrating an example of a shared information storage unit according to the embodiment of the present disclosure.

FIG. 14 is a diagram illustrating an example of a purchased information storage unit according to the embodiment of the present disclosure.

FIG. 15 is a diagram illustrating an example of an operation history information storage unit according to the embodiment of the present disclosure.

FIG. 16 is a diagram illustrating a configuration example of a system administrator terminal according to the embodiment of the present disclosure.

FIG. 17 is a diagram illustrating a configuration example of a store manager terminal according to the embodiment of the present disclosure.

FIG. 18 is a diagram illustrating a configuration example of a general user terminal according to the embodiment of the present disclosure.

FIG. 19 is a flowchart illustrating an information processing procedure according to the embodiment of the present disclosure.

FIG. 20 is a flowchart illustrating the information processing procedure according to the embodiment of the present disclosure.

FIG. 21 is a flowchart illustrating the information processing procedure according to the embodiment of the present disclosure.

FIG. 22 is a flowchart illustrating the information processing procedure according to the embodiment of the present disclosure.

FIG. 23 is a flowchart illustrating the information processing procedure according to the embodiment of the present disclosure.

FIG. 24 is a diagram illustrating an example of a conceptual diagram of a configuration of an information processing system.

FIG. 25 is a diagram illustrating an example of a user interface according to the embodiment.

FIG. 26 is a diagram illustrating an example of the user interface according to the embodiment.

FIG. 27 is a diagram illustrating an example of displayed information.

FIG. 28 is a diagram illustrating an example of displayed information.

FIG. 29 is a diagram illustrating an example of displayed information.

FIG. 30 is a diagram illustrating an example of displayed information.

FIG. 31 is a hardware configuration diagram illustrating an example of a computer that implements functions of the information processing apparatus and a terminal device.

### DESCRIPTION OF EMBODIMENTS

Hereinafter, an embodiment of the present disclosure will be described with reference to the drawings. Note that an information processing apparatus, an information processing method, and an information processing program according to the present application are not limited by the embodiment. In each of the following embodiments, the same parts are denoted by the same reference signs to omit redundant description.

The present disclosure will be described according to the following item order.

1. Embodiment

1-1. Overview of information processing according to embodiment of present disclosure

1-1-1. Example of usage mode of model according to embodiment

1-1-2. Example of model according to embodiment

1-1-3. Model selection example

1-1-4. Mode of model sales and sharing

1-1-5. Automatic generation of meta information

1-1-6. Providing model to data provider

1-1-7. Providing information to user

1-1-8. Listening service

1-1-9. Data provided by user

1-2. Configuration of information processing system according to embodiment

1-3. Configuration of information processing apparatus according to embodiment

1-4. Configuration of terminal device according to embodiment

1-4-1. Configuration of system administrator terminal according to embodiment

1-4-2. Configuration of store manager terminal according to embodiment

1-4-3. Configuration of general user terminal according to embodiment

1-5. Information processing procedure according to embodiment

1-5-1. Registration and sharing of learning model information by general user

1-5-2. Registration and sales registration of learning model information by system administrator

1-5-3. Browsing and selecting process of shared list of learning model information by general user

1-5-4. Sale consignment by store manager and consignment acceptance process by system administrator

1-6. Conceptual diagram of configuration of information processing system

1-6-1. Overall configuration

1-6-2. Server device

1-6-3. System administrator

1-6-4. Store manager

1-6-5. General user

1-6-6. Configuration and effect

1-7. User interface (UI)

1-8. Information display

1-8-1. Screen example of list of created music score data

1-8-2. Screen example for creating StylePallete

1-8-3. Example of screen displaying list of sales-registered StylePalletes

1-8-4. Example of screen displaying list of self-managed StylePalletes

2. Other Embodiments

2-1. Other configuration examples

2-2. Others

3. Effects according to present disclosure

4. Hardware configuration

### 1. Embodiment

[1-1. Overview of information processing according to embodiment of present disclosure]

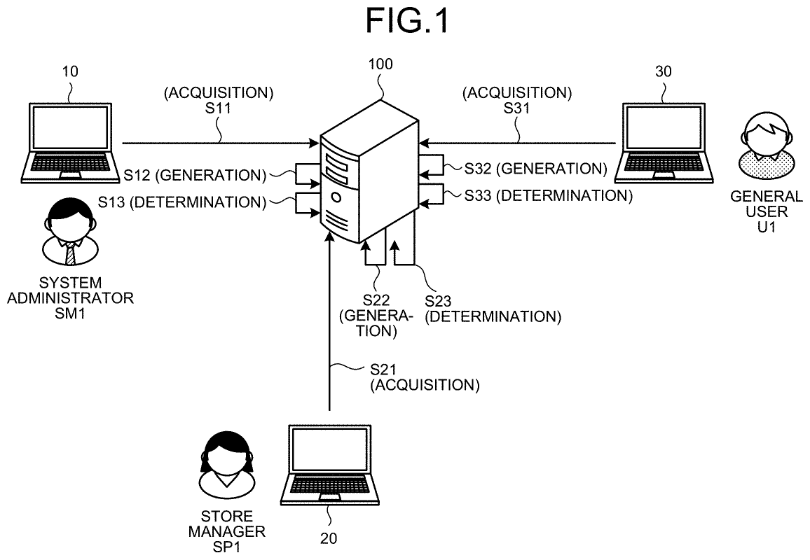

FIG. 1 is a diagram illustrating an example of information processing according to an embodiment of the present disclosure. The information processing according to the embodiment of the present disclosure is realized by an information processing apparatus 100. In the following example, a case where the information processing apparatus 100 is a server device that provides a service related to creation of content as a work (also simply referred to as a “service”) will be described. Note that, in the following description, music (music content) will be described as an example of the content, but the content is not limited to music, and may be various types of content including video content such as a movie and text content such as a book (novel or the like). Furthermore, the music referred to herein is not limited to one completed music (whole music), and is a concept including a part of sound source constituting one piece of music (music) and other various pieces of music information such as a short length of sound used for sampling.

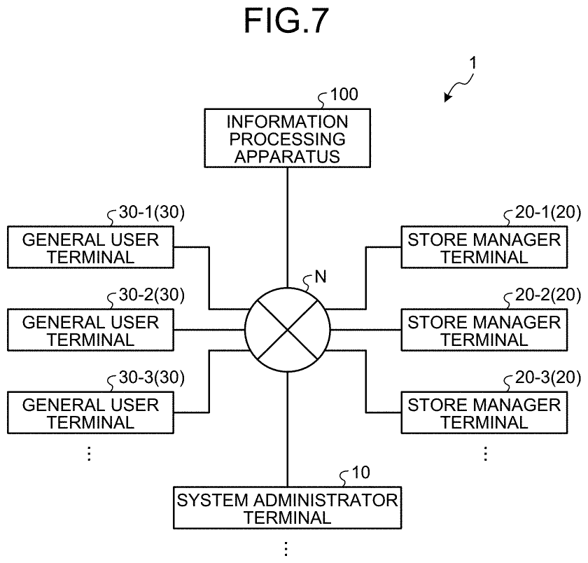

Furthermore, in an example in FIG. 1, the information processing apparatus 100 communicates with a terminal device of a user who uses a service provided by the information processing apparatus 100, using a network N (see FIG. 7) such as the Internet, for example.

Hereinafter, as an example, a case where each user is given three levels of authority according to a usage mode of each user subject (user) of the service provided by the information processing apparatus 100 will be described. Among the users, a user having a system administrator authority is particularly described as a system administrator, a user having a store manager authority is particularly described as a store manager, and a user having a general user authority is described as a general user.

The system administrator authority corresponds to a first authority level (also simply referred to as “first authority”) given to an administrator (system administrator) of the service provided by the information processing apparatus 100. For example, the system administrator having the first authority operates and manages an entire information processing system 1 as a learning model information sharing and selling system. The information processing apparatus 100 communicates with a system administrator terminal 10 used by the system administrator.

The store manager authority corresponds to a second authority level (also simply referred to as “second authority”) given to a seller (store manager) who conducts sales through the service provided by the information processing apparatus 100. In a case where the content (work information) is music (music information), the store manager having the second authority is, for example, a music publishing company, a record label, a DAW software sales company, or the like. The information processing apparatus 100 communicates with a store manager terminal 20 used by the store manager.

The general user authority corresponds to a third authority level (also simply referred to as “third authority”) given to the user (general user) who uses the service provided by the information processing apparatus 100. The general user having the third authority is, for example, the general user who uses the service. The general user includes various users, including a so-called end user, a user who uses the service (tool) for free, and a user who uses the service by subscription. The information processing apparatus 100 communicates with a general user terminal 30 used by the general user. Hereinafter, a case where the first authority level has the broadest authority, the second authority level has an authority limited more than the first authority level, and the third authority level has an authority limited more than the second authority level will be described. As described above, a case where the first authority level to the third authority level have a hierarchical relationship will be described below. Note that the relationship between the authority levels is not limited to the above, and the authority levels may not have overlapping ranges.

It is assumed that software (also referred to as an “application” or an “app”) for realizing a comprehensive music production environment is installed in the system administrator terminal 10, the store manager terminal 20, and the general user terminal 30. Note that the system administrator terminal 10, the store manager terminal 20, and the general user terminal 30 may be referred to as a terminal device when described without particular distinction. For example, the application may be an application (music application) related to various types of music such as a digital audio workstation (DAW). Note that the application referred to herein is not limited to the music application such as DAW, and may be any software as long as it is applicable, and may also be, for example, an operating system (OS) such as Android (registered trademark) or iOS (registered trademark).

In addition, the terminal device has an automatic composition function by AI by using an extended function of the application such as DAW. The terminal device has the automatic composition function by AI by using a plug-in (extended application) added to the application such as DAW by a plug-in function. For example, the plug-in (extended application) may take the form of Steinberg's Virtual Studio Technology (VST) (registered trademark), AudioUnits, Avid Audio eXtension (AAX), or the like.

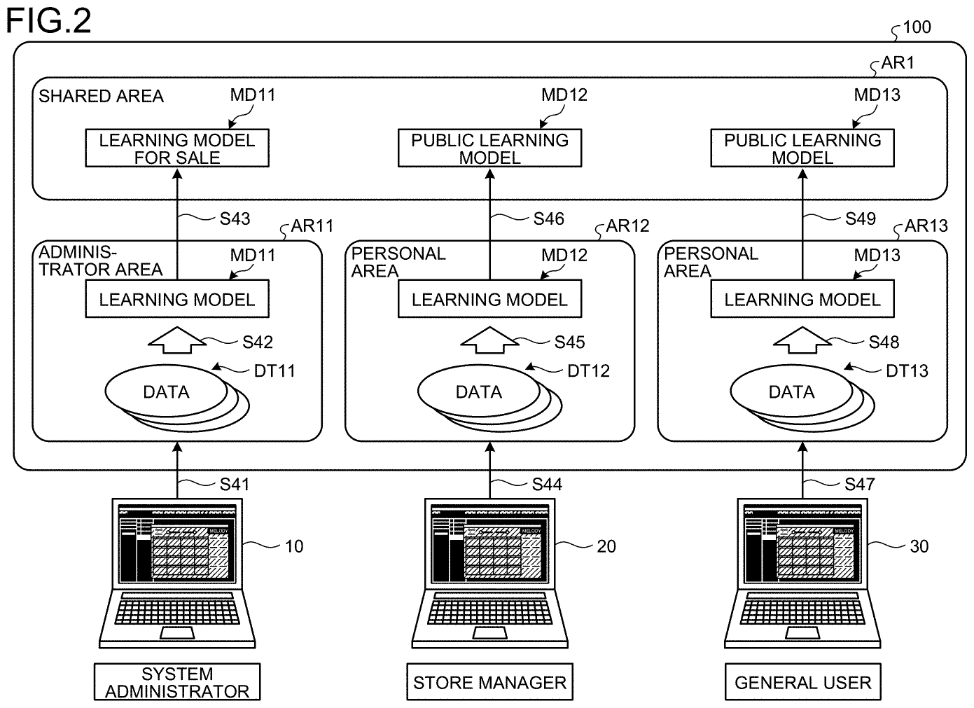

A specific process will be described below with reference to FIG. 1. In the example in FIG. 1, a description will be given on the basis of a case where the DAW is installed as an example of the application in the terminal device of each user. First, an outline of information processing in each device will be described with reference to FIG. 1, and then details of determination of the usage mode will be described with reference to FIGS. 2 to 7.

The example in FIG. 1 illustrates a case where the information processing apparatus 100 generates a learning model (also simply referred to as a “model”) using data provided from the user, and determines the usage mode of the model generated according to the authority of the user who has provided the data. The learning model herein may be any model, and the example in FIG. 1 illustrates a case where the learning model is a model (StylePallete) used for automatic composition of music. Details of the learning model such as the StylePallete will be described later.

The information processing apparatus 100 acquires data used for generating the learning model from the system administrator terminal 10 used by a system administrator SM1 (Step S11). The system administrator SM1 operates the system administrator terminal 10 to transmit the data used for generating the learning model to the information processing apparatus 100. In the example in FIG. 1, the system administrator terminal 10 transmits data DT11 (see FIG. 2) to the information processing apparatus 100. As a result, the information processing apparatus 100 acquires the data used for generating the learning model from the system administrator terminal 10 used by the system administrator SM1 who has the first authority level.

Then, the information processing apparatus 100 generates a learning model using the data provided by the system administrator SM1 (Step S12). In the example in FIG. 1, the information processing apparatus 100 generates a learning model MD11 (see FIG. 2) using the data DT11 provided by the system administrator SM1.

Then, the information processing apparatus 100 determines the usage mode of the learning model generated (Step S13). The information processing apparatus 100 determines the usage mode of the learning model generated according to the authority level of the system administrator SM1 who is a data provider. In the example in FIG. 1, the information processing apparatus 100 determines the usage mode of the learning model MD11 according to the first authority level that is the authority level of the system administrator SM1. The information processing apparatus 100 determines that the learning model MD11 can be used in a service corresponding to the first authority level.

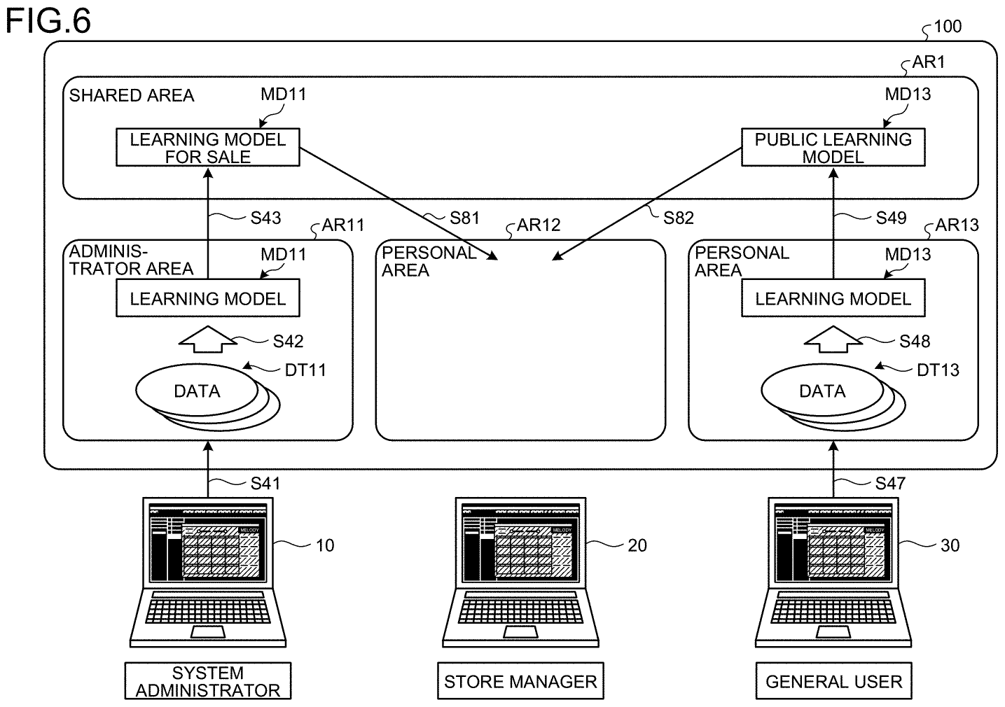

For example, the information processing apparatus 100 may determine the usage mode of the learning model generated by using information indicating an available range (authority range information) corresponding to each of the first authority level to the third authority level. In this case, the information processing apparatus 100 may determine the usage mode of the learning model generated by using the authority range information stored in a storage unit 120 (see FIG. 6). For example, as the usage mode for the first authority level, sales and sharing are available with respect to the model generated using the data of the user to which the first authority level is given (system administrator).

Furthermore, for example, as the usage mode for the second authority level, sale consignment and sharing are available with respect to the model generated using the data of the user to which the second authority level is given (store manager). For example, as the usage mode for the model generated using the data of the second authority level user (store manager), sales of the model can be consigned to the user given the first authority level (system administrator) or the model can be shared by himself/herself. As the usage mode for the model generated using the data of the user given the third authority level, only sharing is available.

In this case, in the authority range information, information indicating that sales and sharing are available is associated with the first authority level, information indicating that sale consignment and sharing are available is associated with the second authority level, and information indicating that sharing is available is associated with the third authority level. For example, the authority range information includes first information in which the usage modes “sales” and “sharing” are associated with the first authority level, second information in which the usage modes “sale consignment” and “sharing” are associated with the second authority level, and third information in which the usage mode “sharing” is associated with the third authority level.

Since the information processing apparatus 100 is given the first authority level that is the authority level of the system administrator SM1, the information processing apparatus 100 determines that the learning model MD11 can be both sold and shared. For example, the information processing apparatus 100 uses the authority range information to determine that the learning model MD11 can be both sold and shared. For example, the information processing apparatus 100 may store information indicating that the usage mode is sales and sharing in the storage unit 120 in association with the learning model MD11.

In addition, the information processing apparatus 100 acquires data used for generating a learning model from the store manager terminal 20 used by a store manager SP1 (Step S21). The store manager SP1 operates the store manager terminal 20 to transmit the data used for generating a learning model to the information processing apparatus 100. In the example in FIG. 1, the store manager terminal 20 transmits data DT12 (see FIG. 2) to the information processing apparatus 100. As a result, the information processing apparatus 100 acquires the data used for generating a learning model from the store manager terminal 20 used by the store manager SP1 to which the second authority level is given.

Then, the information processing apparatus 100 generates a learning model using the data provided by the store manager SP1 (Step S22). In the example in FIG. 1, the information processing apparatus 100 generates a learning model MD12 (see FIG. 2) using the data DT12 provided by the store manager SP1.

Then, the information processing apparatus 100 determines the usage mode of the learning model generated (Step S23). The information processing apparatus 100 determines the usage mode of the learning model generated according to the authority level of the store manager SP1 who is the data provider. In the example in FIG. 1, the information processing apparatus 100 determines the usage mode of the learning model MD12 according to the second authority level that is the authority level of the store manager SP1. The information processing apparatus 100 determines that the learning model MD12 can be used in a service corresponding to the second authority level.

Since the learning model MD12 is given the second authority level that is the authority level of the store manager SP1, the information processing apparatus 100 determines that sale consignment to or sharing of the learning model MD12 with the first authority level user (system administrator) is possible. For example, the information processing apparatus 100 uses the authority range information to determine that the learning model MD12 can be consigned for sales to or shared with the first authority level user (system administrator). For example, the information processing apparatus 100 may store, in the storage unit 120, information indicating that the usage mode is sale consignment to or sharing with the first authority level user (system administrator) in association with the learning model MD12.

Furthermore, the information processing apparatus 100 acquires the data used for generating a learning model from the general user terminal 30 used by a general user U1 (Step S31). The general user U1 operates the general user terminal 30 to transmit the data used for generating the learning model to the information processing apparatus 100.

In the example in FIG. 1, the general user terminal 30 transmits data DT13 (see FIG. 2) to the information processing apparatus 100. As a result, the information processing apparatus 100 acquires data used for generating the learning model from the general user terminal 30 used by the general user U1 given the third authority level.

Then, the information processing apparatus 100 generates a learning model using the data provided by the general user U1 (Step S32). In the example in FIG. 1, the information processing apparatus 100 generates a learning model MD13 (see FIG. 2) using the data DT13 provided by the general user U1.

Then, the information processing apparatus 100 determines the usage mode of the learning model generated (Step S33). The information processing apparatus 100 determines the usage mode of the learning model generated according to the authority level of the general user U1 who is the data provider. In the example in FIG. 1, the information processing apparatus 100 determines the usage mode of the learning model MD13 according to the third authority level that is the authority level of the general user U1. The information processing apparatus 100 determines that the learning model MD13 can be used in a service corresponding to the third authority level.

Since the learning model MD13 is given the third authority level that is the authority level of the general user U1, the information processing apparatus 100 determines that only sharing is available for the learning model MD13. For example, the information processing apparatus 100 uses the authority range information to determine that only sharing is available for the learning model MD13. For example, the information processing apparatus 100 may store, in the storage unit 120, information indicating that the usage mode is sharing in association with the learning model MD13. Note that Steps S11 to S33 are convenient reference signs for describing the process. For example, the process in Steps S31 to S33 may be performed before Steps S11 to S23, or the process in Steps S21 to S23 may be performed before Steps S11 to S13.

As described above, the information processing apparatus 100 determines the usage mode of the model generated according to the authority level of the provider of the data used for generating the model. As a result, the information processing apparatus 100 is capable of appropriately using the model according to the data used for generating the model.

[1-1-1. Example of Usage Mode of Model According to Embodiment]

Hereinafter, the usage mode of the model according to the embodiment will be specifically described with reference to FIGS. 2 to 6. FIGS. 2 to 6 are diagrams illustrating usage mode examples of the model according to the embodiment of the present disclosure. Note that, in FIGS. 2 to 6, the same points as those in FIG. 1 are denoted by the same reference signs, or the like to omit the description thereof as appropriate.

First, a general outline of the usage mode of the model using the data of each user will be described with reference to FIG. 2. FIG. 2 is a diagram illustrating an example of use of regions (areas) in the information processing apparatus 100.

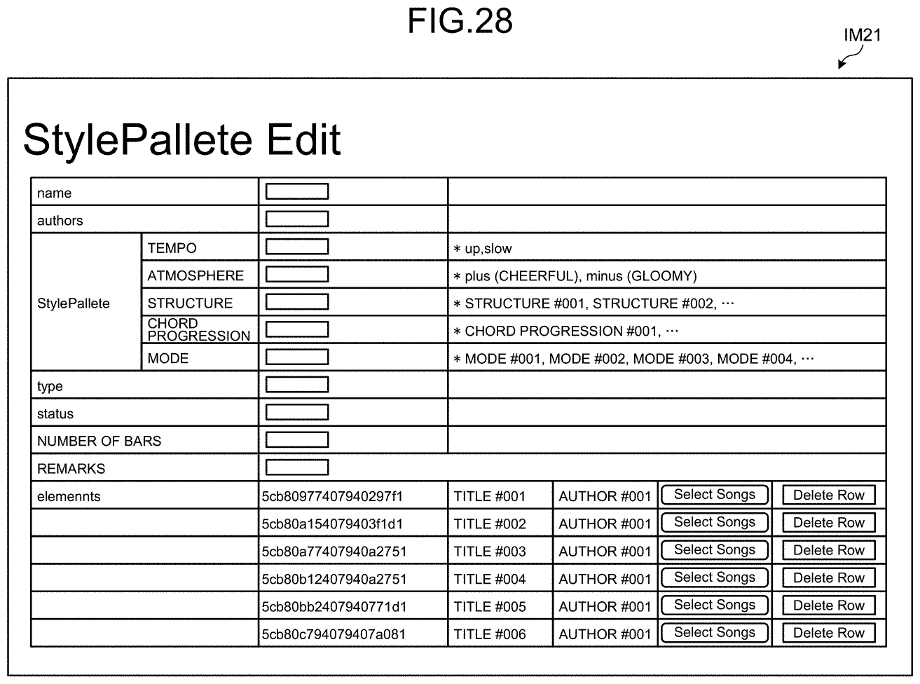

As illustrated in FIG. 2, the system administrator terminal 10, which is the terminal device used by the system administrator having the first authority level, provides the data DT11 used for generating the learning model to the information processing apparatus 100 (Step S41). For example, the system administrator inputs information to a screen IM21 as illustrated in FIG. 28, thereby providing the information processing apparatus 100 with the data DT11 used for generating the StylePallete (learning model). As a result, the information processing apparatus 100 accepts the data DT11. The information processing apparatus 100 that has accepted the data DT11 provided generates the learning model MD11 using the data DT11 (Step S42). Here, since the provider who has provided the data DT11 is the system administrator having the first authority level, the information processing apparatus 100 generates the learning model MD11 in an administrator area AR11. The administrator area AR11 is an area (region) that can be used by the first authority level user. For example, the administrator area AR11 is a region that cannot be accessed by a user having an authority level other than the first authority level. For example, the administrator area AR11 may be provided for each of the first authority level users. For example, in a case where there is a plurality of first authority level users, a plurality of administrator areas AR11 may be provided. In this case, each administrator area AR11 may be a region accessible only by the corresponding first authority level user.

Note that the area (region) referred to herein may be a physically divided region or a logically divided region. For example, each of a shared area AR1, the administrator area AR11, a personal area AR12, and a personal area AR13 may be a region (partition) obtained by virtually (logically) dividing a physical hard disk included in the information processing apparatus 100 into a plurality of hard disks.

Then, the information processing apparatus 100 determines the usage mode of the learning model MD11 (Step S43). For example, the information processing apparatus 100 determines to sell the learning model MD11 on the basis of designation by the system administrator who is the data provider. The information processing apparatus 100 arranges the learning model MD11 as the learning model MD11 for sale in the shared area AR1. In this manner, the system administrator can create learning data and sell the learning data in the shared area. For example, the shared area AR1 is a shared area available to all users having the first authority level to the third authority level. For example, the data arranged in the shared area AR1 may be accessible by all users having the first authority level to the third authority level.

In addition, the store manager terminal 20, which is the terminal device used by the store manager having the second authority level, provides the data DT12 used for generating the learning model to the information processing apparatus 100 (Step S44). For example, the store manager inputs information to the screen IM21 as illustrated in FIG. 28, thereby providing the information processing apparatus 100 with the data DT12 used for generating the StylePallete (learning model). As a result, the information processing apparatus 100 accepts the data DT12. The information processing apparatus 100 that has accepted the data DT12 provided generates the learning model MD12 using the data DT12 (Step S45). Here, since the provider who has provided the data DT12 is the store manager having the second authority level, the information processing apparatus 100 generates the learning model MD12 in the personal area AR12. It is assumed that the personal area AR12 is an area (region) available to the user having the second authority level. For example, the personal area AR12 is a region that cannot be accessed by a user having an authority level other than the second authority level. For example, the personal area AR12 may be provided to each of the second authority level users. For example, when there are ten users having the second authority level, ten personal areas AR12 may be provided. In this case, each personal area AR12 is a region accessible only by the corresponding second authority level user.

Then, the information processing apparatus 100 determines the usage mode of the learning model MD12 (Step S46). For example, the information processing apparatus 100 determines to disclose the learning model MD12 on the basis of the designation by the store manager who is the data provider. The information processing apparatus 100 determines to enable sharing of the learning model MD12 on the basis of the designation by the store manager who is the data provider. The information processing apparatus 100 arranges the learning model MD12 in the shared area AR1 as a public learning model MD12. In this manner, the store manager can create and disclose the learning data.

In addition, the general user terminal 30, which is a terminal device used by the general user having the third authority level, provides the data DT13 used for generating a learning model to the information processing apparatus 100 (Step S47). For example, the general user inputs information to the screen IM21 as illustrated in FIG. 28, thereby providing the information processing apparatus 100 with the data DT13 used for generating the StylePallete (learning model). As a result, the information processing apparatus 100 accepts the data DT13. The information processing apparatus 100 that has accepted the data DT13 provided generates the learning model MD13 using the data DT13 (Step S48). Here, since the provider who has provided the data DT13 is the general user having the third authority level, the information processing apparatus 100 generates the learning model MD13 in the personal area AR13. The personal area AR13 is an area (region) that is available to a third authority level user. For example, the personal area AR13 is a region that cannot be accessed by a user having an authority level other than the third authority level. For example, the personal area AR13 may be provided for each of the third authority level users. For example, when there are 500 third authority level users, 500 personal areas AR13 may be provided. In this case, each personal area AR13 is a region accessible only by the corresponding third authority level user.

Then, the information processing apparatus 100 determines the usage mode of the learning model MD13 (Step S49). For example, the information processing apparatus 100 determines to disclose the learning model MD13 on the basis of designation by the general user who is the data provider. The information processing apparatus 100 determines to enable sharing of the learning model MD13 on the basis of the designation by the general user who is the data provider. The information processing apparatus 100 arranges the learning model MD13 in the shared area AR1 as a public learning model MD13. In this manner, the general user can create and disclose the learning data. Note that Steps S41 to S49 are convenient reference signs for describing the process. For example, the process in Steps S47 to S49 may be performed before Steps S41 to S46, or the process in Steps S44 to S46 may be performed before Steps S41 to S43.

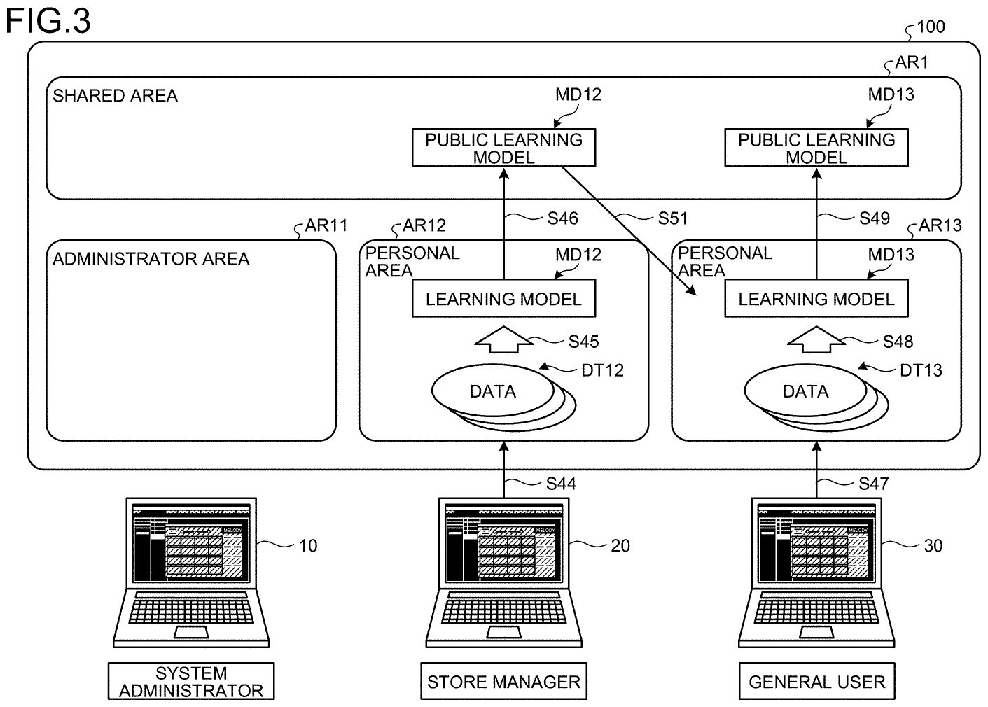

Next, the use of a store manager model by the general user will be described with reference to FIG. 3. FIG. 3 is a diagram illustrating an example of use of the store manager model by the general user. Note that the same points as those in FIG. 2 are denoted by the same reference signs, or the like to omit the description thereof as appropriate.

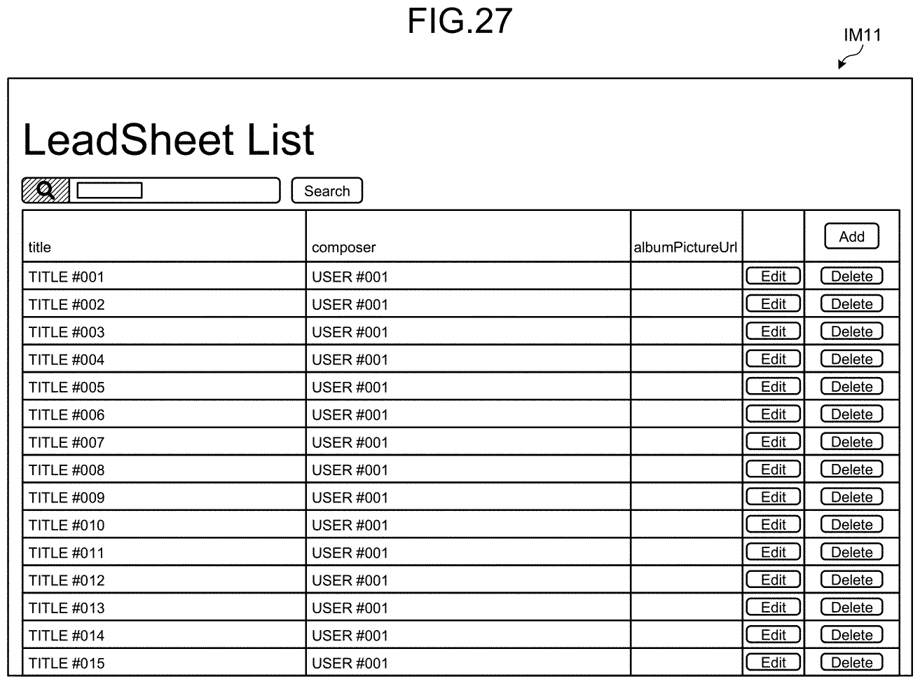

In the example in FIG. 3, the general user having the third authority level requests the use of the public learning model MD12 disclosed by the store manager having the second authority level. Furthermore, when the general user discloses his/her own learning model, the general user can also use a learning model disclosed by other users. For example, when the general user discloses one learning model, the general user can use, for example, three learning models. In this case, the general user can use learning models disclosed by other users three times the number of learning models disclosed by himself/herself. Each user can browse information, and the like, such as by a catalog search without limitation. For example, the information processing apparatus 100 stores the learning model disclosed by each general user and the learning model of another user used in the storage unit 120 in association with each other. For example, the information processing apparatus 100 may provide various types of information such as images IM11 to MI41 illustrated in FIGS. 27 to 30 to the general user terminal 30.

In the example in FIG. 3, since the general user discloses the public learning model MD13, use of the public learning model MD12 is permitted. Therefore, the information processing apparatus 100 provides the public learning model MD12 to the general user (Step S51). For example, the information processing apparatus 100 provides the public learning model MD12 to the personal area AR13 corresponding to the general user. As a result, the general user can use the public learning model MD12 generated by the store manager.

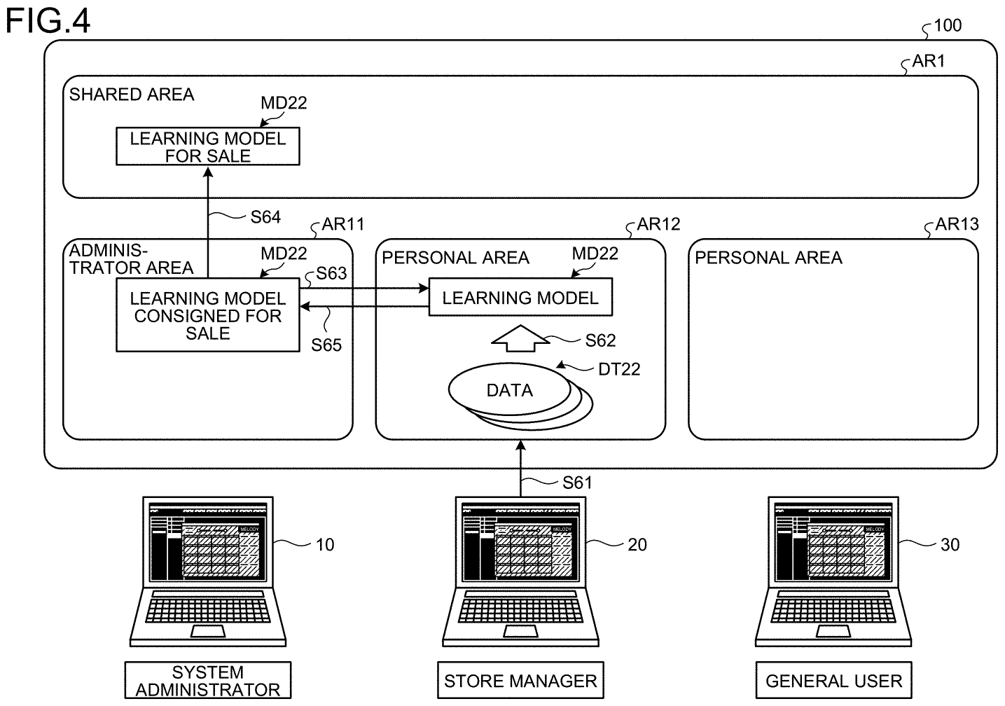

Next, with reference to FIG. 4, sale consignment of the model to the system administrator by the store manager will be described. FIG. 4 is a diagram illustrating an example of model sale consignment from the store manager to the system administrator. Note that the same points as those in FIGS. 2 and 3 are denoted by the same reference signs, or the like to omit the description thereof as appropriate.

In the example in FIG. 4, the store manager terminal 20, which is the terminal device used by the store manager having the second authority level, provides data DT22 used for generating a learning model to the information processing apparatus 100 (Step S61). As a result, the information processing apparatus 100 accepts the data DT22. The information processing apparatus 100 that has accepted the data DT22 provided generates a learning model MD22 using the data DT22 (Step S62). The information processing apparatus 100 generates the learning model MD22 in the personal area AR12.

Then, the store manager requests sale consignment of the learning model MD22 to the system administrator having the first authority level (Step S63). In this manner, the store manager can create the learning data and consign sale to the system administrator. For example, in response to the request for sale consignment of the learning model MD22 from the store manager, the information processing apparatus 100 notifies the system administrator that there has been the request for sale consignment of the learning model MD22. Then, the information processing apparatus 100 may acquire information indicating acceptance of sale consignment of the learning model MD22 from the system administrator.

Then, the system administrator requests the information processing apparatus 100 to sell the learning model MD22 consigned for sale. The information processing apparatus 100 arranges the learning model MD22 consigned for sale as the learning model MD22 for sale in the shared area AR1 (Step S64). In this manner, the system administrator (system management user) can sell the learning data consigned from the store manager (special user) in the shared area. In this manner, the system administrator can sell the learning data consigned from the store manager. Then, the information processing apparatus 100 distributes a revenue obtained by selling the learning model MD22 for sale to the store manager according to the sales of the learning model MD22 for sale (Step S65). The store manager can obtain the revenue according to the sales of the learning model MD22 for sale.

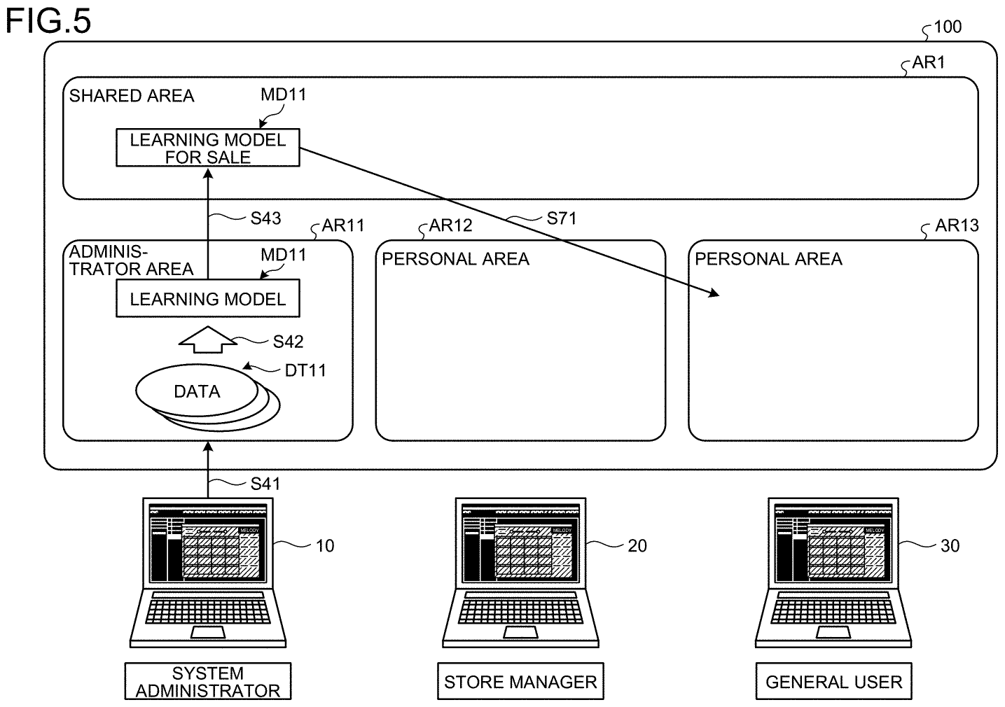

Next, purchase of a model of another user by the general user will be described with reference to FIG. 5. FIG. 5 is a diagram illustrating an example of purchase of a model of the system administrator by the general user. Note that the same points as those in FIGS. 2 to 4 are denoted by the same reference signs, or the like to omit the description thereof as appropriate.

In the example in FIG. 5, the general user having the third authority level requests a purchase of the learning model MD11 for sale sold by the system administrator having the first authority level. In addition, the general user can purchase a learning model for sale. Note that a purchase mode may be a purchase of an individual learning model such as single purchase, or purchase by subscription. Note that each user can browse sales data without limitation.

In the example in FIG. 5, the general user purchases the learning model MD11 for sale by paying a sales price of the learning model MD11 for sale. Note that payment is performed by an appropriate settlement process such as electronic payment. Then, the information processing apparatus 100 provides the learning model MD71 for sale to the general user (Step S71). For example, the information processing apparatus 100 provides the learning model MD11 for sale to the personal area AR13 corresponding to the general user. As a result, the general user can use the learning model MD11 for sale sold by the system administrator. Note that, also in a case where the model purchased by the general user is the learning model MD22 for sale sold on consignment by the system administrator, the same process is performed.

Next, the use of the model of another user by the store manager will be described with reference to FIG. 6. FIG. 6 is a diagram illustrating an example of use of the model of the system administrator and the model of the general user by the store manager. Note that the same points as those in FIGS. 2 to 5 are denoted by the same reference signs, or the like to omit the description thereof as appropriate.

In the example in FIG. 6, the store manager having the second authority level requests the use of the learning model MD11 for sale sold by the system administrator having the first authority level. Here, the store manager can use all pieces of the public learning data and the learning data for sale without limitation. Therefore, the information processing apparatus 100 provides the learning model MD11 for sale to the store manager (Step S81). For example, the information processing apparatus 100 provides the learning model MD11 for sales to the personal area AR12 corresponding to the store manager. As a result, the store manager can use the learning model MD11 for sale sold by the system administrator.

Furthermore, in the example in FIG. 6, the store manager requests the use of the public learning model MD13 disclosed by the general user having the third authority level. As described above, the store manager can use all pieces of the public learning data and the learning data for sale without limitation. Therefore, the information processing apparatus 100 provides the public learning model MD13 to the store manager (Step S82). For example, the information processing apparatus 100 provides the public learning model MD13 to the personal area AR12 corresponding to the store manager. As a result, the store manager can use the public learning model MD13 disclosed by the general user.

As described above, the information processing apparatus 100 shares and sells the learning model according to the authority level of each user. As a result, the information processing apparatus 100 can provide a service to each user corresponding to the authority level of each user.

In the conventional technology, there is no means for sharing only the learning data (learning model) while securely protecting the work itself created by oneself. In addition, there is no means for selling or consigning sales of the learning data (learning model). Furthermore, there is no means for providing the authority of the store manager as the user in addition to the general user and the system administrator, and performing the process according to each authority.

On the other hand, in the information processing system 1, it is possible to share the learning model generated using the content while securely protecting the content itself such as a work created by the user oneself. Furthermore, in the information processing system 1, any one of the first authority level to the third authority level is given to the user according to the attribute of the user or the like, so that the user can sell or share each model according to the authority level of the user. As a result, the information processing system 1 is capable of appropriately using the model according to the data used for generating the model.

[1-1-2. Example of Model According to Embodiment]

As described above, the learning model applicable to the information processing system 1 may be any model. The information processing apparatus 100 may generate a learning model using various techniques related to machine learning. For example, the information processing apparatus 100 may use a music generation algorithm using a Markov chain. The information processing apparatus 100 may generate a learning model using a Markov chain technology. Furthermore, the information processing apparatus 100 may use the music generation algorithm using deep learning. The information processing apparatus 100 may generate a learning model using a technology of deep learning. For example, the information processing apparatus 100 may generate a learning model using a technique of a recursive neural network such as a recurrent neural network (RNN). For example, the information processing apparatus 100 may generate a learning model using a reinforcement learning technique. Note that the description regarding the generation of the model is an example, and the generation of the model may be performed by a learning method appropriately selected according to information that can be acquired, and the like. First, the StylePallete will be described as an example of the learning model.

The StylePallete is the learning model generated on the basis of data. For example, the StylePallete is the learning model generated on the basis of data of music scores including melody, chord progressions, and the like. The information processing apparatus 100 may generate the StylePallete by using data (learning music data) including information, such as melody, chord progressions, and bass sound, as a dataset (learning dataset). The information processing apparatus 100 stores the dataset in association with the StylePallete. The information processing apparatus 100 may generate the StylePallete for automatically creating music data (also simply referred to as “music”) in response to an input of predetermined information. For example, the music data automatically created by the StylePallete may include information such as chord progression, melody, and bass sound progression. The music data may be standard data such as musical instrument digital interface (MIDI) data, waveform data, or unique DAW standard data.

For example, the user may instruct the information processing apparatus 100 to generate the StylePallete (learning model) by inputting information in a generation screen of the StylePallete (learning model) as illustrated in FIG. 28. For example, the user may select the music data (learning music data) used for generating the StylePallete from a list of his/her music data as illustrated in FIG. 27.

For example, the information processing apparatus 100 may generate a StylePallete (cheerful palette) that automatically creates music data with cheerful melody by using music data with a cheerful melody as the learning music data. Furthermore, for example, the information processing apparatus 100 may generate a StylePallete (gloomy palette) that automatically creates music data with gloomy melody by using music data with gloomy melody as the learning music data. Furthermore, for example, the information processing apparatus 100 may generate a StylePallete (palette created based on chord progression) that automatically creates music data corresponding to the predetermined chord progression by using music data corresponding to the predetermined chord progression as the learning music data. Note that the StylePallete is not limited to the above, and may be a palette corresponding to a music category or a type such as “American” or a palette corresponding to a configuration of music such as “Verse→Bridge→Chorus”.

For example, each StylePallete automatically composes music having a feature corresponding to data (music) used for generation. Here, each StylePallete is a learning model generated on the basis of music data having various features. For example, a cheerful palette that is the learning model generated by machine learning using music data with cheerful melody and a gloomy palette that is the learning model generated by machine learning using music data of a gloomy melody are different. Therefore, the music to be automatically composed changes according to the StylePallete selected by the user. Accordingly, the user can automatically compose desired music by selecting the StylePallete according to his/her desire.

For example, the information processing apparatus 100 may generate the StylePallete for automatically creating a plurality of pieces of music data at random in response to an instruction of automatic creation. For example, the information processing apparatus 100 may generate the StylePallete (cheerful palette) that automatically creates a plurality of pieces of music data with cheerful melody at random in response to the instruction of automatic creation. For example, the information processing apparatus 100 may generate the StylePallete (gloomy palette) for automatically creating a plurality of pieces of music data with gloomy melody at random in response to the instruction of automatic creation. For example, the information processing apparatus 100 may generate the StylePallete (palette created based on chord progression) for automatically creating music data corresponding to a plurality of predetermined chord progressions at random in response to the instruction of automatic creation.

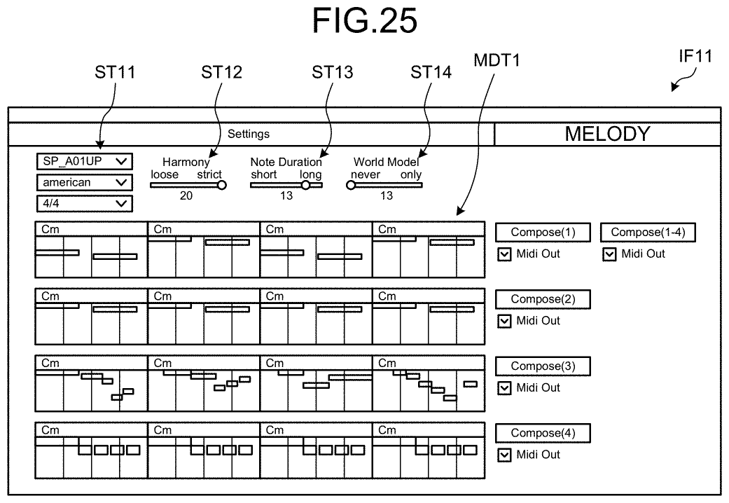

The information processing apparatus 100 may generate the StylePallete using information (parameters) corresponding to setting information ST12 to ST14 illustrated in FIG. 25. The information processing apparatus 100 may generate the StylePallete using the parameters corresponding to harmony, note duration, and the like. For example, the information processing apparatus 100 may generate the StylePallete using predetermined information as an input. For example, the information processing apparatus 100 may generate the StylePallete using information (parameters) corresponding to the setting information ST12 to ST14 illustrated in FIG. 25 as the input. For example, in a case where a parameter is input, the information processing apparatus 100 may generate a StylePallete for automatically creating a plurality of pieces of music data at random. Note that the above is an example, and the StylePallete may be a learning model that outputs any information as long as the user can use the learning model for automatically creating music.

From here, various types of information processing using the learning model such as the StylePallete will be described.

[1-1-3. Model Selection Example]

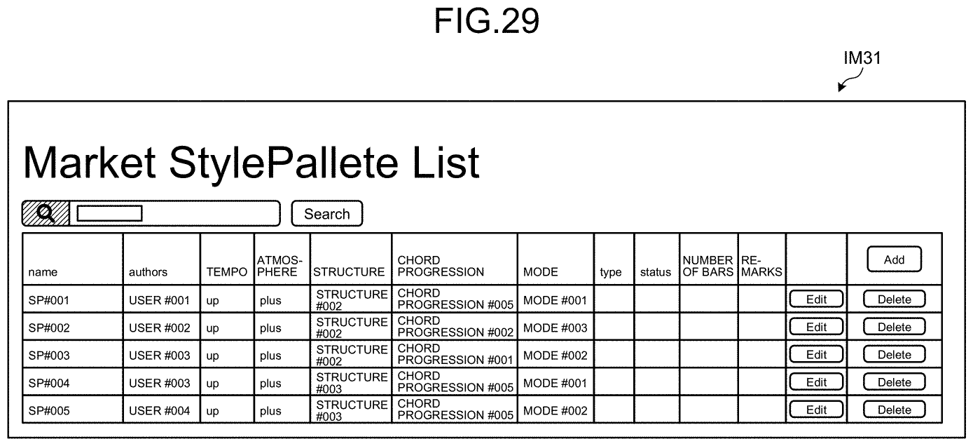

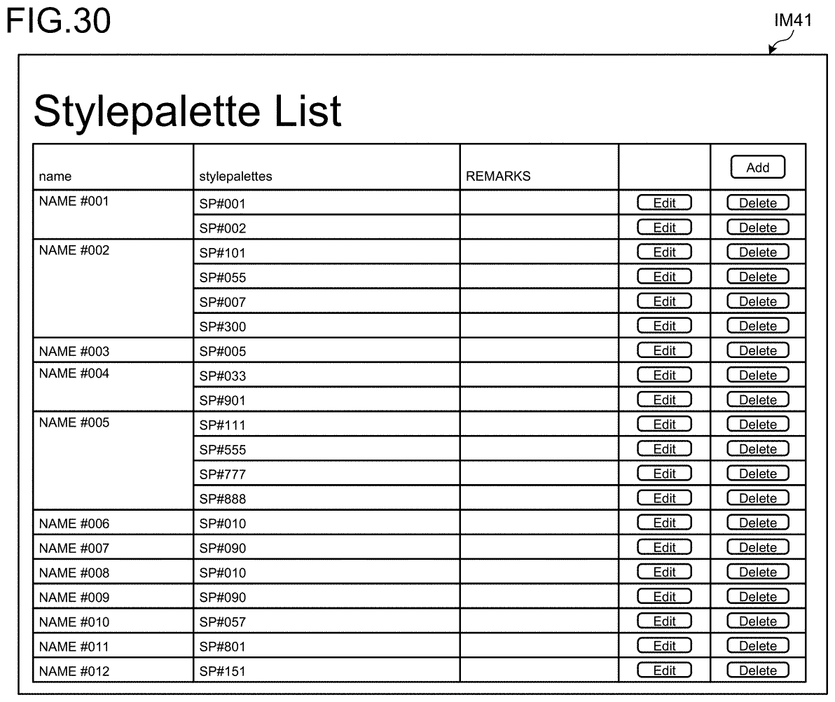

First, selection of the learning model (StylePallete) to be used by the user will be described. The user selects a StylePallete that the user desires to use from a list of StylePalletes as illustrated in FIGS. 29 and 30. The user selects an image that matches the music to be automatically composed by the StylePallete. For example, in a case where the user desires to automatically compose music with cheerful melody, the user selects a cheerful palette. For example, when the user wants to automatically compose music with gloomy melody, the user selects a gloomy palette. For example, in a case where the user desires to automatically compose music corresponding to a predetermined chord progression, the user selects a palette created based on the chord progression.

Note that the user may select a plurality of StylePalletes when selecting the StylePallete. For example, the user may select a first StylePallete to compose a part of music (e.g., leading eight bars) and a second StylePallete different from the first StylePallete to compose a different part of the music (e.g., middle eight bars). Information including such a plurality of StylePalletes is hereinafter referred to as a StylePallete sequence. In other words, the StylePallete sequence is combined designation information that is created by combining designation information for designating music pieces called StylePalletes. The user can easily create various music data having a plurality of features in one piece of music by setting a StylePallete sequence to composing music.

[1-1-4. Mode of Model Sales and Sharing]

The information processing apparatus 100 may individually sell or share each learning model (StylePallete). Furthermore, the information processing apparatus 100 may sell or share a plurality of StylePalletes as one bundle. The information processing apparatus 100 may sell or share 20 StylePalletes generated on the basis of music of a specific artist as one bundle. For example, the information processing apparatus 100 may sell or share one bundle (bundle) corresponding to name #002 including a plurality of StylePalletes such as StylePalletes SP #101, SP #055, SP #007, and SP #300 as illustrated in FIG. 30.

[1-1-5. Automatic Generation of Meta Information]

The information processing apparatus 100 may generate meta information of the learning model. For example, the information processing apparatus 100 generates the meta information corresponding to the model on the basis of the data provided by the user subject. For example, in a case where the music data provided is music with gloomy melody, the information processing apparatus 100 may generate meta information including information indicating gloomy melody as the meta information of a StylePallete to be generated. For example, in a case where the music data provided is music corresponding to a specific chord progression, the information processing apparatus 100 may generate meta information including information indicating a gloomy-specific chord progression as the meta information of the StylePallete to be generated.

[1-1-6. Providing Model to Data Provider]

The information processing apparatus 100 may transmit the model to the terminal device used by the user subject that is the data provider. The information processing apparatus 100 may transmit the model to the terminal device used by the user subject that is the data provider at a timing when model generation is completed. For example, the information processing apparatus 100 may generate a model at a timing that the data is accepted, and transmit the model to the terminal device used by the user subject that is the data provider at a timing that the model is generated.

For example, the information processing apparatus 100 may generate the StylePallete at the timing that the data is accepted, and transmit the StylePallete to the terminal device used by the user subject that is the data provider at the timing that the StylePallete is generated. In this manner, the information processing apparatus 100 generates the StylePallete and transmits the StylePallete generated to the terminal device as soon as there is a request for generating the StylePallete. For example, since time required for generating the StylePallete is shorter than, for example, learning of another generated model, the information processing apparatus 100 can perform a process from acceptance of the request to generation and transmission of the StylePallete in a short time.

[1-1-7. Providing Information to User]

The information processing apparatus 100 may provide various types of information to the user. For example, the information processing apparatus 100 may provide various types of information to the user in response to the request from the user. The information processing apparatus 100 may determine information to be provided to the user on the basis of a service use history of the user.

The information processing apparatus 100 may determine a plurality of models to provide information to the user on the basis of the service use history of the user. In this case, the information processing apparatus 100 generates list information of the plurality of determined models and transmits the list information to the terminal device of the user.

The information processing apparatus 100 may determine the model to recommend (recommended model) to the user on the basis of a behavior history or preference of each user. The information processing apparatus 100 determines a recommended model recommended to be used by the user among the plurality of models.

[1-1-8. Listening Service]

As described above, in a case where the content is music, the information processing apparatus 100 may provide a listening service to the user. For example, the information processing apparatus 100 may provide the listening service for music generated when using the model.

In a case where the listening service is provided, the information processing apparatus 100 may accept selection of StylePallete by the user and cause the user to listen to the music automatically composed using the StylePallete accepted. As a result, the user can check what kind of music will be created.

[1-1-9. Data Provided by User]

In a case where the data provided by the user is applicable to a predetermined condition, the information processing apparatus 100 may not register the data. For example, in a case where the user requests registration of the content that another subject has a copyright as data to be provided by the user, the information processing apparatus 100 may not perform the registration. For example, in a case where the user requests registration of music (music X) of a certain artist as data provided by the user, the information processing apparatus 100 may reject the registration.

In this case, the information processing apparatus 100 may notify the user who has requested the registration that the registration is rejected. For example, the information processing apparatus 100 may determine whether the content whose registration is requested by the user is the content that another subject has a copyright by referring to a predetermined database. For example, the information processing apparatus 100 may provide the content whose registration is requested by the user to an external service providing apparatus that provides a service for determining presence or absence of a copyright, and determine whether or not another subject holds the copyright of the content by using a determination result received from the external service providing apparatus.

[1-2. Configuration of Information Processing System According to Embodiment]

The information processing system 1 illustrated in FIG. 7 will be described. FIG. 7 is a diagram illustrating a configuration example of the information processing system according to the embodiment of the present disclosure. As illustrated in FIG. 7, the information processing system 1 includes the information processing apparatus 100, the system administrator terminal 10, store manager terminals 20-1 to 20-3, and general user terminals 30-1 to 30-3. The information processing system 1 functions as a work management system, a learning model information management system, a learning model information sharing system, a learning model information sales system, and a learning model information sharing and selling system.

In an example in FIG. 7, three store manager terminals 20-1, 20-2, and 20-3 are illustrated, but are referred to as the store manager terminal 20 when described without particular distinction. The number of store manager terminals 20 included in the information processing system 1 is not limited to three, and may be more or less than three. In addition, in the example in FIG. 7, three general user terminals 30-1, 30-2, and 30-3 are illustrated, but are referred to as the general user terminal 30 when described without particular distinction. The number of general user terminals 30 included in the information processing system 1 is not limited to three, and may be more or less than three. Furthermore, the information processing system 1 may include a plurality of information processing apparatuses 100 and a plurality of system administrator terminals 10. The information processing apparatus 100, the system administrator terminal 10, the store manager terminal 20, and the general user terminal 30 are communicably connected in a wired or wireless manner via a predetermined communication network (network N).

The information processing apparatus 100 provides a service related to creation of content. The information processing apparatus 100 is an information processing apparatus that generates a model regarding content generation by using data provided by a service user subject, and determines the usage mode of the model generated according to the authority level of the user subject. The information processing apparatus 100 transmits and receives information to and from the system administrator terminal 10 used by the system administrator who is the service user subject. The information processing apparatus 100 transmits and receives information to and from the store manager terminal 20 used by the store manager who is the service user subject. The information processing apparatus 100 transmits and receives information to and from the general user terminal 30 used by the general user who is the service user subject.

The system administrator terminal 10 is the terminal device (information processing apparatus) used by the system administrator having the first authority. The system administrator terminal 10 is used, for example, by the system administrator to operate and manage the entire information processing system 1. The system administrator terminal 10 may be, for example, a device such as a smartphone, a tablet terminal, a notebook personal computer (PC), a desktop PC, a mobile phone, or a personal digital assistant (PDA). The examples in FIGS. 1 to 6 illustrate the case where the system administrator terminal 10 is a notebook PC.

The store manager terminal 20 is the terminal device (information processing apparatus) used by the store manager having the second authority. The store manager terminal 20 is used, for example, by the store manager to consign sales of music. The store manager terminal 20 may be, for example, a device such as a smartphone, a tablet terminal, a notebook PC, a desktop PC, a mobile phone, or a PDA. The examples in FIGS. 1 to 6 illustrate the case where the store manager terminal 20 is a notebook PC.

The general user terminal 30 is the terminal device (information processing apparatus) used by the general user having the third authority. The general user terminal 30 is used, for example, by the general user to share or purchase music. The general user terminal 30 may be, for example, a device such as a smartphone, a tablet terminal, a notebook PC, a desktop PC, a mobile phone, or a PDA. The examples in FIGS. 1 to 6 illustrate the case where the general user terminal 30 is a notebook PC.

The store manager authority corresponds to a second authority level (also simply referred to as “second authority”) given to a seller (store manager) who conducts sales through the service provided by the information processing apparatus 100. In a case where the content (work information) is music (music information), the store manager having the second authority is, for example, a music publishing company, a record label, a DAW software sales company, or the like. The information processing apparatus 100 communicates with a store manager terminal 20 used by the store manager.

The general user authority corresponds to a third authority level (also simply referred to as “third authority”) given to the user (general user) who uses the service provided by the information processing apparatus 100. The general user having the third authority is, for example, the general user who uses the service. The general user includes various users, including a so-called end user, a user who uses the service (tool) for free, and a user who uses the service by subscription. The information processing apparatus 100 communicates with a general user terminal 30 used by the general user.

[1-3. Configuration of Information Processing Apparatus According to Embodiment]

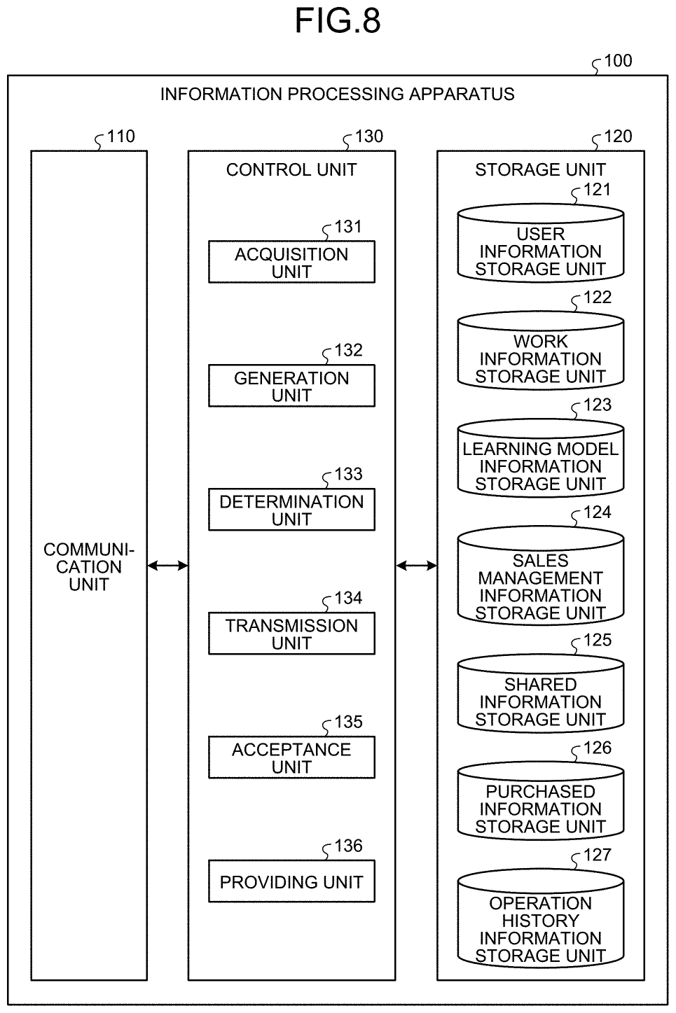

Next will be described a configuration of the information processing apparatus 100 that is an example of the information processing apparatus that executes information processing according to the embodiment. FIG. 8 is a diagram illustrating a configuration example of the information processing apparatus 100 according to the embodiment of the present disclosure.

As illustrated in FIG. 8, the information processing apparatus 100 includes a communication unit 110, the storage unit 120, and a control unit 130. Note that the information processing apparatus 100 may include an input unit (e.g., a keyboard or a mouse) that receives various operations from the administrator or the like of the information processing apparatus 100, and a display unit (e.g., a liquid crystal display) for displaying various types of information.

The communication unit 110 is realized by, for example, a network interface card (NIC) or the like. Then, the communication unit 110 is connected to the network N (see FIG. 7) in a wired or wireless manner, and transmits and receives information to and from other information processing apparatuses such as the system administrator terminal 10, the store manager terminal 20, and the general user terminal 30.

The storage unit 120 is realized by, for example, a semiconductor memory element such as a random access memory (RAM) or a flash memory, or a storage device such as a hard disk or an optical disk. As illustrated in FIG. 8, the storage unit 120 according to the embodiment includes a user information storage unit 121, a work information storage unit 122, a learning model information storage unit 123, a sales management information storage unit 124, a shared information storage unit 125, a purchased information storage unit 126, and an operation history information storage unit 127. Note that, although not illustrated, the storage unit 120 may store various types of information such as an image that will be a source of image to be provided to the system administrator terminal 10.

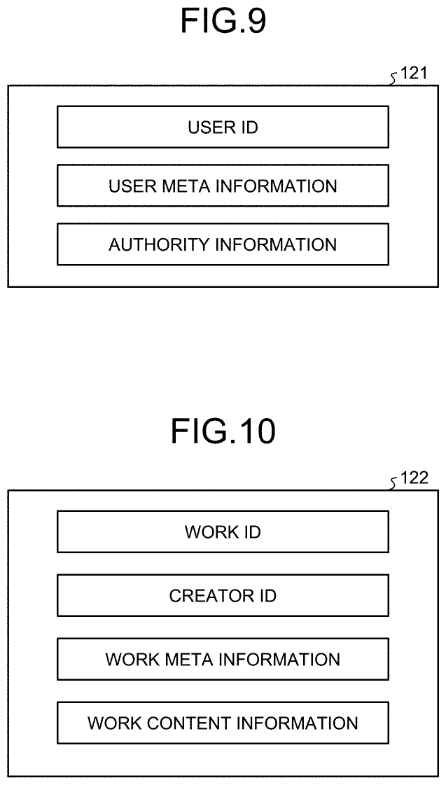

The user information storage unit 121 according to the embodiment stores various types of information regarding the user (user information). FIG. 9 is a diagram illustrating an example of the user information storage unit according to the embodiment of the present disclosure.

The user information storage unit 121 stores the user information including a user ID, user meta information, and authority information. The user information storage unit 121 stores the user meta information and the authority information corresponding to each user ID in association with each user ID.

The user ID indicates identification information for uniquely specifying each user. For example, the user ID indicates the identification information for uniquely specifying the user such as the system administrator, the store manager, or the general user. The user meta information is, for example, additional information of the user such as a name and an address of the user.

The authority information stores, for example, a value for identifying the authority such as system administrator authority information, store manager authority information, and general user authority information. The authority information stores, for example, values for identifying authority, such as value “1” for identifying the system administrator, value “2” for identifying the store manager, and value “3” for identifying the general user. For example, when the corresponding user is the system administrator, the value corresponding to the system administrator authority information (e.g., 1) is stored in the authority information. For example, when the corresponding user is the store manager, the value corresponding to the store manager authority information (e.g., 2) is stored in the authority information. For example, when the corresponding user is the general user, the value corresponding to the general user authority information (e.g., 3) is stored in the authority information.

Note that the user information storage unit 121 is not limited to the above, and may store various types of information according to purposes. The user meta information is not limited to the name and the address, and various kinds of information related to the user may be stored. For example, when the user is a natural person, demographic attribute information such as gender and age of the user, psychographic attribute information, and the like may be stored in the user meta information.

The work information storage unit 122 according to the embodiment stores various kinds of information related to a work (work information). FIG. 10 is a diagram illustrating an example of the work information storage unit according to the embodiment.

The work information storage unit 122 stores the work information including a work ID, a creator ID, work meta information, and the work content information. The work information storage unit 122 stores the creator ID, the work meta information, and work content information corresponding to each work ID in association with each work ID.

The work ID indicates identification information for uniquely specifying the work. The creator ID indicates the identification information for uniquely specifying the creator of the corresponding work. For example, the creator ID indicates the identification information for uniquely specifying the user such as the system administrator, the store manager, or the general user. The work meta information is, for example, information such as a music title, a composer, an age, and a category. The work content information is, for example, information on melody and chord progression of the music.

Note that the work information storage unit 122 is not limited to the above, and may store various types of information according to purposes. For example, the work meta information may store various kinds of additional information related to the work such as information related to a date and time when the work is created.

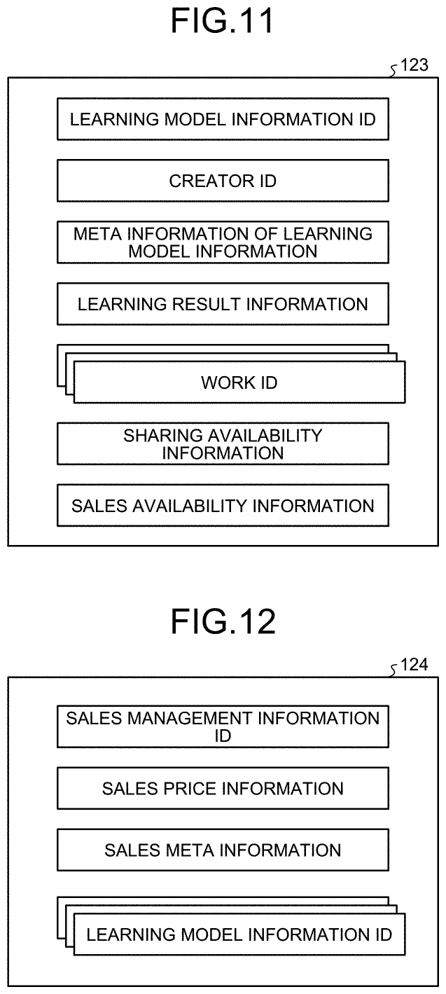

The learning model information storage unit 123 according to the embodiment stores information regarding a trained model (learning model information). FIG. 11 is a diagram illustrating an example of the learning model information storage unit according to the embodiment of the present disclosure.

The learning model information storage unit 123 stores the learning model information including a learning model information ID, a creator ID, meta information of learning model information, learning result information, a work ID, sharing availability information, and sales availability information. The learning model information storage unit 123 stores the creator ID, the meta information of learning model information, the learning result information, the work ID, the sharing availability information, and the sales availability information corresponding to each learning model information ID in association with each learning model information ID.

The learning model information ID indicates identification information for uniquely specifying the learning model information. The creator ID indicates identification information for uniquely specifying the creator of the corresponding learning model information. For example, the creator ID indicates the identification information for uniquely specifying the user such as the system administrator, the store manager, or the general user.

The meta information of learning model information is, for example, information indicating a feature of a work to be learned. The meta information of learning model information is a music tone such as tempo, category, and cheerful or gloomy melody, a song structure such as verse, bridge, and chorus, chord progression, scale, a church mode, and the like. The learning result information stores a result of processing by a learning process unit (generation unit 132) or the like included in the information processing apparatus 100. The work ID indicates identification information for uniquely specifying each of a plurality of works to be learned.

The sharing availability information indicates, for example, whether or not the corresponding learning model can be shared. As the sharing availability information, for example, a value for specifying and identifying whether or not the corresponding learning model can be shared is stored. As the sharing availability information, for example, in a case where the corresponding learning model can be shared, a value “1” indicating that sharing is possible is stored, and in a case where the corresponding learning model cannot be shared, a value “2” indicating that sharing is not possible is stored.

The sales availability information indicates, for example, whether or not the corresponding learning model can be sold. As the sales availability information, for example, a value for specifying and identifying whether or not the corresponding learning model can be sold is stored. As the sales availability information, for example, when the corresponding learning model can be sold, value “1” indicating that sales is possible is stored, and when the corresponding learning model cannot be sold, value “2” indicating that sales is not possible is stored.

Note that the learning model information storage unit 123 is not limited to the above, and may store various types of information according to purposes. For example, in the meta information of learning model information, various types of additional information related to the learning model, such as information related to a date and time when the learning model is created, may be stored.

The sales management information storage unit 124 according to the embodiment stores various types of information regarding sales (sales management information). FIG. 12 is a diagram illustrating an example of the sales management information storage unit according to the embodiment of the present disclosure.

The sales management information storage unit 124 stores the sales management information including a sales management information ID, sales price information, sales meta information, and a learning model information ID. The sales management information storage unit 124 stores the sales price information, the sales meta information, and the learning model information ID corresponding to each sales management information ID in association with each sales management information ID.

The sales management information ID indicates identification information for uniquely specifying the sales management information. The sales price information is, for example, information such as a sales price and tax. The sales meta information is, for example, information such as a sales product name and a sales company name.

The learning model information ID indicates identification information for uniquely specifying the learning model information. For example, when the sales management information identified by the corresponding sales management information ID is a single product having one piece of learning model information, one learning model information ID is associated with this sales management information ID. For example, when the sales management information identified by the corresponding sales management information ID is a bundle product having a plurality of pieces of learning model information, a plurality of pieces of learning model information IDs is associated with the sales management information ID.

Note that the sales management information storage unit 124 is not limited to the above, and may store various types of information according to purposes. For example, the sales meta information may store various kinds of additional information related to sales, such as information related to a date and time when sales have been started.

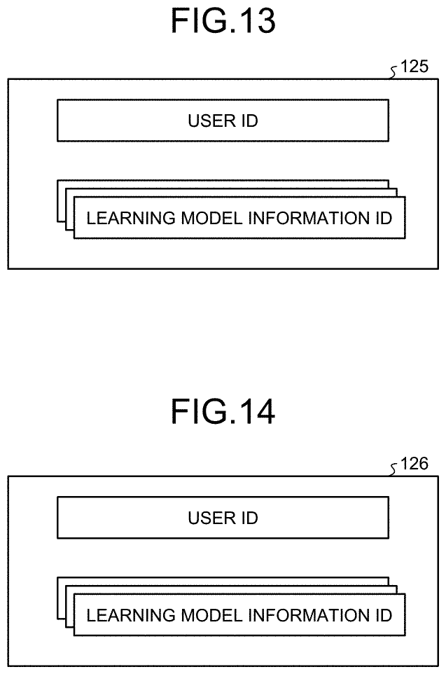

The shared information storage unit 125 according to the embodiment stores various types of information regarding sharing (shared information). The shared information storage unit 125 stores shared bookmark list information. For example, the shared information storage unit 125 stores list information of the learning models to which the shared bookmark has been added. FIG. 13 is a diagram illustrating an example of the shared information storage unit according to the embodiment of the present disclosure.

The shared information storage unit 125 stores the shared information including the user ID and the learning model information ID. The shared information storage unit 125 stores the learning model information ID corresponding to each user ID in association with each user ID. The shared information storage unit 125 stores the learning model information ID for identifying the learning model added to the shared bookmark by the user identified by the user ID in association with each user ID.

The user ID indicates identification information for uniquely specifying each user. For example, the user ID indicates the identification information for uniquely specifying the user such as the system administrator, the store manager, or the general user.

The learning model information ID indicates identification information for uniquely specifying the learning model information. For example, when the user identified by the corresponding user ID adds the shared bookmark to a plurality of learning models, the user ID is associated with the plurality of learning model information IDs. For example, when the corresponding user ID does not add the shared bookmark, the user ID is not associated with the learning model information ID.

Note that the shared information storage unit 125 is not limited to the above, and may store various types of information according to purposes.

The purchased information storage unit 126 according to the embodiment stores information regarding purchase (purchase information). The purchased information storage unit 126 stores user purchased list information. For example, the purchased information storage unit 126 stores list information of learning models purchased by the user. FIG. 14 is a diagram illustrating an example of the purchased information storage unit according to the embodiment of the present disclosure.

The purchased information storage unit 126 stores the purchase information including the user ID and the learning model information ID. The purchased information storage unit 126 stores the learning model information ID corresponding to each user ID in association with each user ID. The purchased information storage unit 126 stores each user ID in association with the learning model information ID for identifying the learning model purchased by the user identified by the user ID.

The user ID indicates identification information for uniquely specifying each user. For example, the user ID indicates the identification information for uniquely specifying the user such as the system administrator, the store manager, or the general user.

The learning model information ID indicates identification information for uniquely specifying the learning model information. For example, when the user identified by the corresponding user ID purchases a plurality of learning models, the user ID is associated with the plurality of learning model information IDs. For example, when the corresponding user ID does not purchase the learning model, the user ID is not associated with the learning model information ID.

Note that the purchased information storage unit 126 is not limited to the above, and may store various types of information according to purposes.

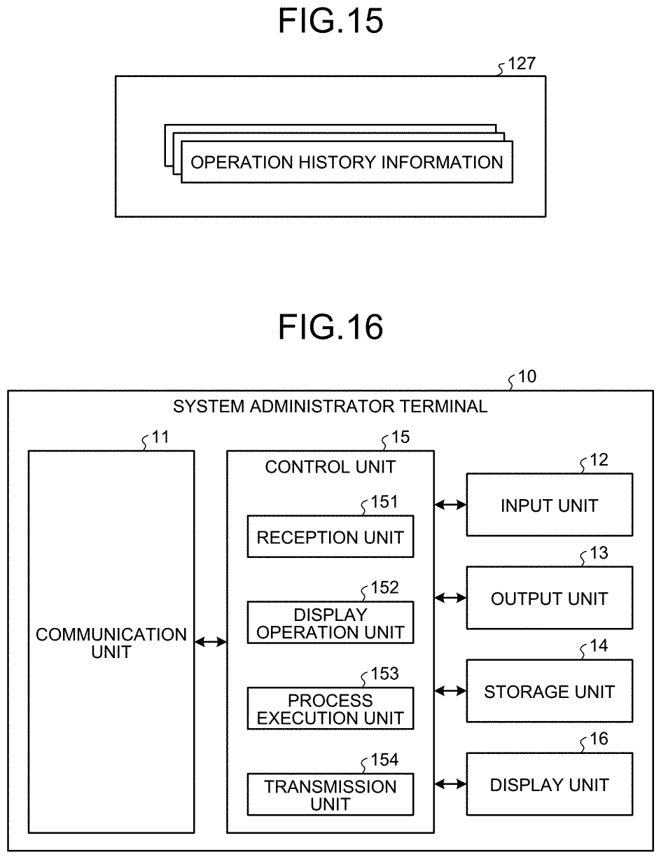

The operation history information storage unit 127 according to the embodiment stores information regarding the operation history of the user (operation history information). The operation history information storage unit 127 stores user operation history list information. For example, the operation history information storage unit 127 stores list information of operation history of each user. FIG. 15 is a diagram illustrating an example of the operation history information storage unit according to the embodiment of the present disclosure.

The operation history information storage unit 127 stores the operation history information. For example, the operation history information storage unit 127 stores an operation history corresponding to each user ID in association with each user ID. The operation history information storage unit 127 stores the operation history of the user identified by the user ID in association with each user ID.

The operation history information indicates the operation history of the user. For example, the operation history information may include various types of information regarding the operation by the user, such as details of the operation performed by the user and the date and time when the operation is performed.

Note that the operation history information storage unit 127 is not limited to the above, and may store various types of information according to purposes.

Returning to FIG. 8, the description will be continued. The control unit 130 is implemented by, for example, a central processing unit (CPU), a micro processing unit (MPU), or the like executing a program (e.g., a determination program such as the information processing program according to the present disclosure) stored inside the information processing apparatus 100, using a RAM or the like as a work area. Furthermore, the control unit 130 is a controller, and is realized by, for example, an integrated circuit such as an application specific integrated circuit (ASIC) or a field programmable gate array (FPGA).

As illustrated in FIG. 8, the control unit 130 includes an acquisition unit 131, the generation unit 132, a determination unit 133, a transmission unit 134, an acceptance unit 135, and a providing unit 136, and implements or executes a function and an action of information processing described below. Note that an internal configuration of the control unit 130 is not limited to the configuration illustrated in FIG. 8, and may be another configuration as long as information processing to be described later is performed. Furthermore, a connection relationship of process units included in the control unit 130 is not limited to the connection relationship illustrated in FIG. 8, and may be another connection relationship.

The acquisition unit 131 acquires various types of information. The acquisition unit 131 acquires various types of information from an external information processing apparatus. The acquisition unit 131 acquires various types of information from other information processing apparatuses such as the system administrator terminal 10, the store manager terminal 20, and the general user terminal 30.

The acquisition unit 131 acquires various types of information from the storage unit 120. The acquisition unit 131 acquires various types of information from the user information storage unit 121, the work information storage unit 122, the learning model information storage unit 123, the sales management information storage unit 124, the shared information storage unit 125, the purchased information storage unit 126, and the operation history information storage unit 127.

The acquisition unit 131 acquires various types of information determined by the determination unit 133. The acquisition unit 131 acquires various types of information generated by the generation unit 132. The acquisition unit 131 acquires various types of information received by the acceptance unit 135.

In the example in FIG. 1, the acquisition unit 131 acquires data used for generating the learning model from the system administrator terminal 10 used by the system administrator SM1. The acquisition unit 131 acquires the data used for generating the learning model from the store manager terminal 20 used by the store manager SP1. The acquisition unit 131 acquires the data used for generating the learning model from the general user terminal 30 used by the general user U1.

The generation unit 132 generates various types of information. The generation unit 132 generates various types of information on the basis of information from the external information processing apparatuses and information stored in the storage unit 120. The generation unit 132 generates various types of information on the basis of information from other information processing apparatuses such as the system administrator terminal 10, the store manager terminal 20, and the general user terminal 30. The generation unit 132 generates various types of information on the basis of information stored in the user information storage unit 121, the work information storage unit 122, the learning model information storage unit 123, the sales management information storage unit 124, the shared information storage unit 125, the purchased information storage unit 126, or the operation history information storage unit 127.

The generation unit 132 generates various types of information on the basis of the various types of information acquired by the acquisition unit 131. The generation unit 132 generates various types of information on the basis of the various types of information determined by the determination unit 133. The generation unit 132 generates various types of information on the basis of the various types of information determined by the acceptance unit 135.

The generation unit 132 performs a learning process. The generation unit 132 functions as a learning process unit that performs the learning process. For example, the generation unit 132 is a learning process function unit. The generation unit 132 performs various kinds of learning. The generation unit 132 learns (generates) the model. The generation unit 132 learns various types of information such as the model. The generation unit 132 generates a model by learning. The generation unit 132 learns the model using various techniques related to machine learning. The generation unit 132 updates the model by learning.

For example, the generation unit 132 learns various types of information on the basis of information from the external information processing apparatuses and information stored in the storage unit 120. The generation unit 132 learns various types of information on the basis of information from other information processing apparatuses such as the system administrator terminal 10, the store manager terminal 20, and the general user terminal 30. The generation unit 132 learns various types of information on the basis of information stored in the user information storage unit 121, the work information storage unit 122, the sales management information storage unit 124, the shared information storage unit 125, the purchased information storage unit 126, and the operation history information storage unit 127.

The generation unit 132 learns various types of information on the basis of the various types of information acquired by the acquisition unit 131. The generation unit 132 learns various types of information on the basis of the various types of information determined by the determination unit 133. The generation unit 132 learns various types of information on the basis of the various types of information determined by the acceptance unit 135.

The generation unit 132 generates the learning model using various techniques related to machine learning. The generation unit 132 may use the music generation algorithm using the Markov chain. The information processing apparatus 100 may generate a learning model using a Markov chain technology. Furthermore, the information processing apparatus 100 may use the music generation algorithm using deep learning. The information processing apparatus 100 generates the learning model using a deep learning technology. The generation unit 132 generates the learning model using a technique of a recursive neural network such as RNN. The generation unit 132 may generate the learning model using a reinforcement learning technique.

The generation unit 132 generates a model regarding content generation by using data provided by the user subject of the service having one of the plurality of authority levels of the service regarding content creation. The generation unit 132 generates a model by using data provided by the user subject having one of the plurality of authority levels including the first authority level given to a service administrator, the second authority level given to the seller who conducts sales in the service, and the third authority level given to the general user who uses the service.

The generation unit 132 generates a model by using data provided by the user subject having one of the plurality of authority levels including the second authority level whose authority is limited more than the first authority level and the third authority level whose authority is limited more than the second authority level. The generation unit 132 generates a model by using data provided by the user subject having one of the plurality of authority levels including the first authority level that can accept consignment from the user subject having the second authority level. The generation unit 132 generates the model by using data provided by the user subject having one of the plurality of authority levels including the second authority level that can sell and share a model generated by the data of the user subject having the second authority level. The generation unit 132 generates a model by using data provided by the user subject having one of the plurality of authority levels including the third authority level that can share the model generated by data of the user subject having the third authority level.

The generation unit 132 generates the meta information corresponding to the model on the basis of the data provided by the user subject. The generation unit 132 generates a model at a timing that the acceptance unit 135 accepts the data. The generation unit 132 generates the list information of the plurality of models determined by the determination unit 133.

The generation unit 132 generates a model regarding music generation by using the data provided by the user subject having one of the plurality of authority levels in a service regarding creation of music, which is content.

The generation unit 132 generates various types of information such as a screen (image information) or the like to be provided to the external information processing apparatuses by appropriately using various technologies. The generation unit 132 generates the screen (image information) or the like to be provided to the system administrator terminal 10. For example, the generation unit 132 generates the screen (image information) or the like to be provided to the system administrator terminal 10 on the basis of the information stored in the storage unit 120.

The generation unit 132 may generate the screen (image information) or the like by any process as long as the screen (image information) or the like to be provided to the external information processing apparatuses can be generated. For example, the generation unit 132 generates the screen (image information) to be provided to the system administrator terminal 10 by appropriately using various technologies related to image generation, image processing, and the like. For example, the generation unit 132 generates the screen (image information) to be provided to the system administrator terminal 10 by appropriately using various technologies such as Java (registered trademark). Note that the generation unit 132 may generate the screen (image information) to be provided to the system administrator terminal 10 on the basis of a format such as CSS, JavaScript (registered trademark), or HTML. Furthermore, for example, the generation unit 132 may generate the screen (image information) in various formats such as joint photographic experts group (JPEG), graphics interchange format (GIF), or portable network graphics (PNG). The generation unit 132 generates images IM11, IM21, IM31, IM41, and the like. The generation unit 132 generates various types of information regarding user interfaces IF11 to IF13.

In the example in FIG. 1, the generation unit 132 generates a learning model using the data provided from the system administrator SM1. The generation unit 132 generates a learning model using the data provided from the store manager SP1. The generation unit 132 generates a learning model using the data provided from the general user U1.

The determination unit 133 decides various types of information. The determination unit 133 determines various types of information. For example, the determination unit 133 decides various types of information on the basis of the information from the external information processing apparatus or the information stored in the storage unit 120. The determination unit 133 determines various types of information on the basis of information from an external information processing apparatus and information stored in the storage unit 120. The determination unit 133 decides various types of information on the basis of information from other information processing apparatuses such as the system administrator terminal 10, the store manager terminal 20, and the general user terminal 30. The determination unit 133 decides various types of information on the basis of information stored in the user information storage unit 121, the work information storage unit 122, the learning model information storage unit 123, the sales management information storage unit 124, the shared information storage unit 125, the purchased information storage unit 126, or the operation history information storage unit 127.

The determination unit 133 decides various types of information on the basis of the various types of information acquired by the acquisition unit 131. The determination unit 133 decides various types of information on the basis of the various types of information generated by the generation unit 132. The determination unit 133 decides various types of information on the basis of the various types of information received by the acceptance unit 135.

The determination unit 133 determines the usage mode of the model generated by the generation unit 132 according to one authority level of the user subject. The determination unit 133 determines a use range of the model in the service according to one authority level. The determination unit 133 decides whether or not the model can be sold or shared according to one authority level.

When one authority level possessed by the user subject is the first authority level, the determination unit 133 decides that the model can be used in the service corresponding to the first authority level. When one authority level possessed by the user subject is the second authority level, the determination unit 133 decides that the model can be used in the service corresponding to the second authority level. When one authority level possessed by the user subject is the third authority level, the determination unit 133 decides that the model can be used in the service corresponding to the third authority level.

The determination unit 133 decides information to be provided to one user subject on the basis of the service use history of the one user subject. The determination unit 133 decides a plurality of models to provide information to the one user subject. The determination unit 133 decides a recommended model recommended to be used by the one user subject among the plurality of models.

In the example in FIG. 1, the determination unit 133 decides the usage mode of the generated learning model according to the authority level of the system administrator SM1 who is the data provider. The determination unit 133 decides the usage mode of the generated learning model according to the authority level of the store manager SP1 who is the data provider. The determination unit 133 decides the usage mode of the learning model generated according to the authority level of the general user U1 who is the data provider.

The transmission unit 134 provides various types of information to the external information processing apparatuses. The transmission unit 134 transmits various types of information to the external information processing apparatuses. For example, the transmission unit 134 transmits various types of information to other information processing apparatuses such as the system administrator terminal 10, the store manager terminal 20, and the general user terminal 30. The transmission unit 134 provides the information stored in the storage unit 120. The transmission unit 134 transmits the information stored in the storage unit 120.

The transmission unit 134 provides various types of information on the basis of information from other information processing apparatuses such as the system administrator terminal 10, the store manager terminal 20, and the general user terminal 30. The transmission unit 134 provides various types of information on the basis of the information stored in the storage unit 120. The transmission unit 134 provides various types of information on the basis of the information stored in the user information storage unit 121, the work information storage unit 122, the learning model information storage unit 123, the sales management information storage unit 124, the shared information storage unit 125, the purchased information storage unit 126, or the operation history information storage unit 127.

The transmission unit 134 transmits various types of information acquired by the acquisition unit 131. The transmission unit 134 transmits various types of information generated by the generation unit 132. The transmission unit 134 transmits the various types of information decided by the determination unit 133. The transmission unit 134 transmits various types of information provided by the providing unit 136 in response to an instruction from the providing unit 136. The transmission unit 134 transmits various types of information received by the acceptance unit 135 to other information processing apparatuses such as the system administrator terminal 10, the store manager terminal 20, and the general user terminal 30.

The transmission unit 134 transmits the model to the terminal device used by the user subject. The transmission unit 134 transmits the model to the terminal device at the timing that the generation unit 132 generates the model. The transmission unit 134 transmits the model to the system administrator terminal 10 that is the terminal device used by the system administrator. The transmission unit 134 transmits the model to the system administrator terminal 10 that is the terminal device used by the system administrator at the timing that the generation unit 132 generates the model using the data provided by the system administrator.

The transmission unit 134 transmits the model to the store manager terminal 20 that is the terminal device used by the store manager. The transmission unit 134 transmits the model to the store manager terminal 20 that is the terminal device used by the store manager at the timing that the generation unit 132 generates the model using the data provided by the store manager. The transmission unit 134 transmits the model to the general user terminal 30 that is the terminal device used by the general user. The transmission unit 134 transmits the model to the general user terminal 30 that is the terminal device used by the general user at the timing that the generation unit 132 generates the model using the data provided by the general user.

The acceptance unit 135 accepts various types of information. The acceptance unit 135 accepts registration of various types of information. The acceptance unit 135 accepts a request for various types of information.

The acceptance unit 135 receives various types of information. The acceptance unit 135 receives various types of information from the external information processing apparatuses. The acceptance unit 135 receives various types of information from other information processing apparatuses such as the system administrator terminal 10, the store manager terminal 20, and the general user terminal 30.

The acceptance unit 135 accepts data from the user subject. The acceptance unit 135 accepts data from the system administrator. The acceptance unit 135 accepts data from the system administrator terminal 10 that is the terminal device used by the system administrator. The acceptance unit 135 accepts data from the store manager. The acceptance unit 135 accepts data from the store manager terminal 20 that is the terminal device used by the store manager. The acceptance unit 135 accepts data from the general user. The acceptance unit 135 accepts data from the general user terminal 30 that is the terminal device used by the general user.

In the example in FIG. 1, the acceptance unit 135 accepts the data DT11 provided from the system administrator terminal 10. The acceptance unit 135 accepts the data DT11 provided. The acceptance unit 135 accepts the data DT12 provided from the store manager terminal 20. The acceptance unit 135 accepts the data DT11 provided. The acceptance unit 135 accepts the data DT13 provided from the general user terminal 30.

The providing unit 136 provides various types of information. The providing unit 136 provides various types of information to other information processing apparatuses such as the system administrator terminal 10, the store manager terminal 20, and the general user terminal 30. For example, the providing unit 136 provides various types of information on the basis of the information from the external information processing apparatuses and the information stored in the storage unit 120. The providing unit 136 provides various types of information on the basis of the information from other information processing apparatuses such as the system administrator terminal 10, the store manager terminal 20, and the general user terminal 30. The providing unit 136 provides various types of information on the basis of the information stored in the user information storage unit 121, the work information storage unit 122, the learning model information storage unit 123, the sales management information storage unit 124, the shared information storage unit 125, the purchased information storage unit 126, and the operation history information storage unit 127.

The providing unit 136 provides various types of information on the basis of the various types of information acquired by the acquisition unit 131. The providing unit 136 provides various types of information on the basis of the various types of information generated by the generation unit 132. The providing unit 136 provides various types of information on the basis of the various types of information decided by the determination unit 133. The providing unit 136 provides various types of information on the basis of the various types of information received by the acceptance unit 135. The providing unit 136 provides information by instructing the transmission unit 134 to cause the transmission unit 134 to transmit various types of information.

The providing unit 136 provides a listening service of music. The providing unit 136 provides the listening service of music generated when the model is used.

[1-4. Configuration of Terminal Device According to Embodiment]

Next, the terminal device used by each user according to the embodiment will be described.

[1-4-1. Configuration of System Administrator Terminal According to Embodiment]

First, a configuration of the system administrator terminal 10 that is an example of the terminal device according to an embodiment will be described. FIG. 16 is a diagram illustrating a configuration example of the system administrator terminal according to the embodiment of the present disclosure.

As illustrated in FIG. 16, the system administrator terminal 10 includes a communication unit 11, an input unit 12, an output unit 13, a storage unit 14, a control unit 15, and a display unit 16.

The communication unit 11 is realized by, for example, the NIC or a communication circuit. The communication unit 11 is connected to the network N (the Internet or the like) in a wired or wireless manner, and transmits and receives information to and from other devices such as the information processing apparatus 100 and other terminal devices via the network N.

The user inputs various operations to the input unit 12. The input unit 12 includes a keyboard or a mouse connected to the system administrator terminal 10. The input unit 12 accepts an input by the user. The input unit 12 accepts the input by the user via the keyboard or the mouse. The input unit 12 may have a function of detecting sound. In this case, the input unit 12 may include a microphone that detects the sound.

Various types of information may be input to the input unit 12 via the display unit 16. In this case, the input unit 12 may have a touch panel capable of realizing functions equivalent to those of the keyboard or the mouse. In this case, the input unit 12 receives various operations from the user via a display screen using the function of the touch panel realized by various sensors. In other words, the input unit 12 receives various operations from the user via the display unit 16 of the system administrator terminal 10. For example, the input unit 12 receives an operation such as a designation of the user via the display unit 16 of the system administrator terminal 10. For example, the input unit 12 functions as an acceptance unit that accepts the operation by the user using the function of the touch panel. Note that, as a method of detecting the user's operation by the input unit 12, a capacitance method is mainly adopted in the tablet terminal. However, any other detection methods may be adopted as long as the user's operation can be detected and the function of the touch panel can be realized, such as a resistive film method, a surface acoustic wave method, an infrared method, and an electromagnetic induction method. In addition, when a button or the like is provided in the system administrator terminal 10, the system administrator terminal 10 may have an input unit that also accepts an operation using the button or the like.

The output unit 13 outputs various types of information. The output unit 13 has a function of outputting sound. For example, the output unit 13 includes a speaker that outputs sound. Note that when sound output is not performed, the system administrator terminal 10 may not include the output unit 13.

The storage unit 14 is realized by, for example, a semiconductor memory element such as a RAM or a flash memory, or a storage device such as a hard disk or an optical disk. The storage unit 14 stores various types of information used for displaying information.

Returning to FIG. 16, the description will be continued. The control unit 15 is implemented by, for example, the CPU, the MPU, or the like executing the program (for example, a display program such as an information processing program according to the present disclosure) stored in the system administrator terminal 10, using the RAM or the like as a work area. Furthermore, the control unit 15 is a controller, and may be realized by, for example, the integrated circuit such as the ASIC or the FPGA.

As illustrated in FIG. 16, the control unit 15 includes a reception unit 151, a display operation unit 152, a process execution unit 153, and a transmission unit 154, and implements or executes a function and an action of information processing described below. Note that the internal configuration of the control unit 15 is not limited to the configuration illustrated in FIG. 16, and may be another configuration as long as information processing to be described later is performed.

The reception unit 151 receives various types of information. The reception unit 151 receives various types of information from the external information processing apparatus. The reception unit 151 receives various types of information from other information processing apparatuses such as the information processing apparatus 100 and other terminal devices. The reception unit 151 receives various types of information from the information processing apparatus 100 and other terminal devices. The reception unit 151 receives service information regarding creation of content, such as information regarding the learning model, from the information processing apparatus 100.

The reception unit 151 receives control information from the information processing apparatus 100. The reception unit 151 receives an image from the information processing apparatus 100. The reception unit 151 receives the image including the control information from the information processing apparatus 100. The reception unit 151 receives the images IM11, IM21, IM31, IM41, and the like from the information processing apparatus 100. The reception unit 151 receives various types of information related to the user interfaces IF11 to IF13 from the information processing apparatus 100.

The display operation unit 152 controls various displays. The display operation unit 152 controls a display on the display unit 16. The display operation unit 152 controls the display on the display unit 16 in response to reception by the reception unit 151. The display operation unit 152 controls the display on the display unit 16 on the basis of the information received by the reception unit 151. The display operation unit 152 controls the display on the display unit 16 on the basis of the information generated by the process execution unit 153. The display operation unit 152 controls display on the display unit 16 in accordance with generation by the process execution unit 153. The display operation unit 152 controls the display of the display unit 16 such that the image received from the information processing apparatus 100 is displayed on the display unit 16.

The display operation unit 152 may control the display of the display unit 16 by an application that displays the images IM11, IM21, IM31, IM41, and the like. The display operation unit 152 may control the display of the display unit 16 by an application that displays various types of information regarding the user interfaces IF11 to IF13. The display operation unit 152 may be realized by an application. The display operation unit 152 controls the display on the display unit 16 according to predetermined control information. Here, the control information is described by, for example, a script language such as JavaScript (registered trademark), CSS, or the like.

The process execution unit 153 executes various processes. The process execution unit 153 executes various processes on the basis of information from the external information processing apparatuses and information stored in the storage unit 14. The process execution unit 153 executes various processes on the basis of information from other information processing apparatuses such as the information processing apparatus 100 and other terminal devices. The process execution unit 153 executes various processes on the basis of the information received by the reception unit 151.

The transmission unit 154 transmits various types of information to the external information processing apparatus. For example, the transmission unit 154 transmits various types of information to other information processing apparatuses such as the information processing apparatus 100 and other terminal devices. The transmission unit 154 transmits the information stored in the storage unit 14.

The transmission unit 154 transmits various types of information on the basis of information from another information processing apparatus such as the information processing apparatus 100. The transmission unit 154 transmits various types of information on the basis of the information stored in the storage unit 14.

The transmission unit 154 transmits various types of information to the information processing apparatus 100 and other terminal devices according to the operation. The transmission unit 154 transmits various types of information to the information processing apparatus 100 and other terminal devices according to the user's operation. The transmission unit 154 transmits information requesting the use of the model to the information processing apparatus 100 according to the user's operation. The transmission unit 154 transmits information requesting purchase or sharing of the model to the information processing apparatus 100 according to the user's operation.

The display unit 16 displays various types of information. The display unit 16 is realized by, for example, a liquid crystal display, an organic electro-luminescence (EL) display, or the like. The display unit 16 may be realized by any means as long as the information provided from the information processing apparatus 100 can be displayed. The display unit 16 displays various types of information under the control of the information processing apparatus 100. The display unit 16 displays various types of information according to the control information received by the reception unit 151 from the information processing apparatus 100. The display unit 16 displays various types of information under the control of the display operation unit 152. The display unit 16 displays an image provided from the information processing apparatus 100. The display unit 16 displays various types of information generated by the process execution unit 153. The display unit 16 displays the images IM11, IM21, IM31, IM41, and the like. The display unit 16 displays the user interfaces IF11 to IF13 and the like.

Note that the processes such as the display control process, the generation process, and the display process by the control unit 15 described above may be realized by, for example, a predetermined application in each unit of the control unit 15. For example, processes such as the display control process, generation process, and display process by the control unit 15 may be realized by control information including JavaScript (registered trademark) and the like. Furthermore, in a case where the above-described display control process, generation process, display process, or the like is performed by a dedicated application, the control unit 15 may include, for example, an application control unit that controls the predetermined application (for example, a web browser or the like) or the dedicated application.

[1-4-2. Configuration of Store Manager Terminal According to Embodiment]

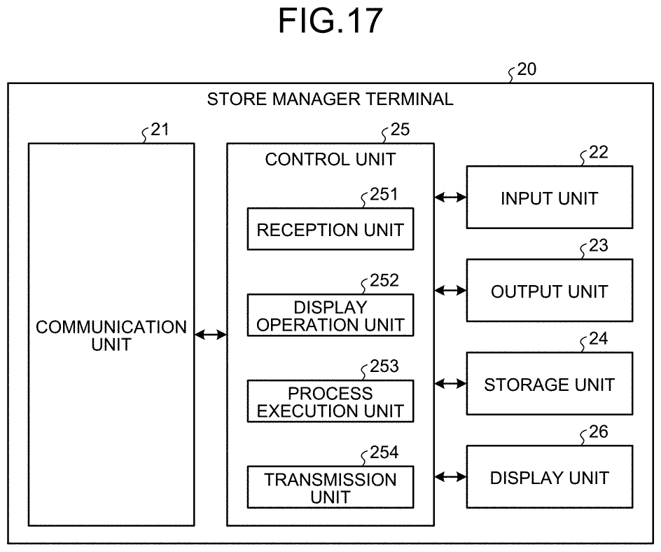

Next will be described a configuration of the store manager terminal 20 that is an example of the terminal device executing the information processing according to the embodiment. FIG. 17 is a diagram illustrating a configuration example of the store manager terminal according to the embodiment of the present disclosure. Note that, in the store manager terminal 20, a configuration same as or corresponding to the configuration of the system administrator terminal 10 is denoted by reference signs starting with “2” (“2*” or “2**”) to omit redundant description.

As illustrated in FIG. 17, the store manager terminal 20 includes a communication unit 21, an input unit 22, an output unit 23, a storage unit 24, a control unit 25, and a display unit 26.

As illustrated in FIG. 17, the control unit 25 includes a reception unit 251, a display operation unit 252, a process execution unit 253, and a transmission unit 254.

[1-4-3. Configuration of General User Terminal According to Embodiment]

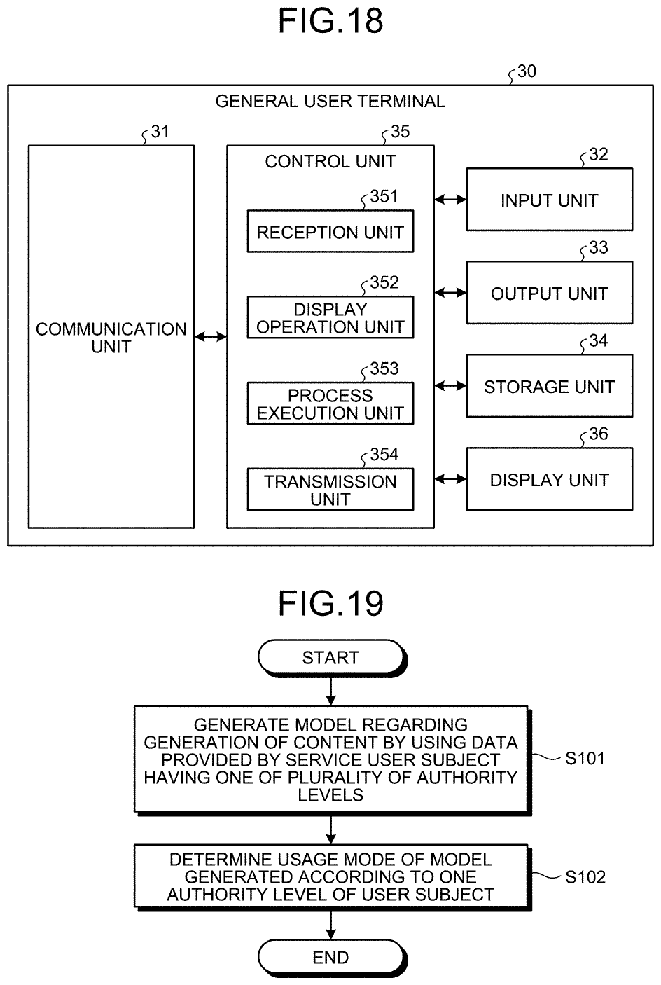

Next will be described a configuration of the general user terminal 30 that is an example of the terminal device executing the information processing according to the embodiment. FIG. 18 is a diagram illustrating a configuration example of the general user terminal according to the embodiment of the present disclosure. Note that, in the general user terminal 30, a configuration that is the same as or corresponding to the configuration of the system administrator terminal 10 is denoted by a reference sign starting with “3” (“3*” or “3**”) to omit redundant description.

As illustrated in FIG. 18, the general user terminal 30 includes a communication unit 31, an input unit 32, an output unit 33, a storage unit 34, a control unit 35, and a display unit 36.

As illustrated in FIG. 18, the control unit 35 includes a reception unit 351, a display operation unit 352, a process execution unit 353, and a transmission unit 354.

[1-5. Information Processing Procedure According to Embodiment] Next, various types of information processing procedures according to the embodiment will be described with reference to FIG. 19. FIG. 19 is a flowchart illustrating the information processing procedure according to the embodiment of the present disclosure.

As illustrated in FIG. 19, the information processing apparatus 100 generates a model regarding content generation by using data provided by the service user subject having one of the plurality of authority levels (Step S101). In the example in FIG. 1, the information processing apparatus 100 generates a learning model MD11 (see FIG. 2) using the data DT11 provided by the system administrator SM1.

The information processing apparatus 100 determines the usage mode of the generated model according to one authority level of the user subject (Step S102). In the example in FIG. 1, since the information processing apparatus 100 has the first authority level that is the authority level of the system administrator SM1, it is determined that the learning model MD11 can be sold or shared.

[1-5-1. Registration and Sharing of Learning Model Information by General User]

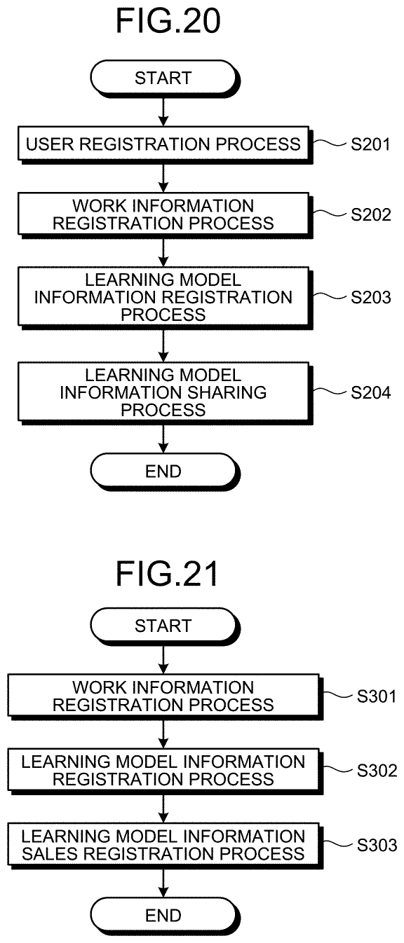

Next, registration and sharing of learning model information by the general user will be described with reference to FIG. 20. FIG. 20 is a flowchart illustrating the information processing procedure according to the embodiment of the present disclosure. Specifically, FIG. 20 is a diagram (sequence diagram) illustrating the procedure of registration and sharing of the learning model information by the general user. Note that a process in each step illustrated in FIG. 20 may be performed by any device included in the information processing system 1, such as the information processing apparatus 100 or the terminal device (e.g., the general user terminal 30).

As illustrated in FIG. 20, the information processing system 1 performs a user registration process (Step S201). The information processing system 1 performs the user registration process in response to a request from the general user. For example, the information processing apparatus 100 performs a process of registering a user who uses the general user terminal 30 in the user information storage unit 121 as the general user in response to the request from the general user terminal 30.

Further, the information processing system 1 performs a work information registration process (Step S202). The information processing system 1 performs the work information registration process in response to the request from the general user. For example, the information processing apparatus 100 performs a process of registering the work information acquired from the general user terminal 30 in the work information storage unit 122 in response to the request from the general user terminal 30.

Furthermore, the information processing system 1 performs a learning model information registration process (Step S203). The information processing system 1 performs the learning model information registration process in response to the request from the general user. For example, the information processing apparatus 100 performs a process of registering the learning model information acquired from the general user terminal 30 in the learning model information storage unit 123 in response to the request from the general user terminal 30.

Furthermore, the information processing system 1 performs a learning model information sharing process (Step S204). The information processing system 1 performs the learning model information sharing process in response to the request from the general user. For example, the information processing apparatus 100 changes a state of sharing availability of the learning model information acquired from the general user terminal 30 in response to the request from the general user terminal 30.

[1-5-2. Registration and Sales Registration of Learning Model Information by System Administrator]

Next, registration and sales registration of the learning model information by the system administrator will be described with reference to FIG. 21. FIG. 21 is a flowchart illustrating the information processing procedure according to the embodiment of the present disclosure. Specifically, FIG. 21 is a diagram (sequence diagram) illustrating registration and sales registration of the learning model information by the system administrator. Note that a process in each step illustrated in FIG. 21 may be performed by any device included in the information processing system 1, such as the information processing apparatus 100 or the terminal device (e.g., the system administrator terminal 10).

As illustrated in FIG. 21, the information processing system 1 performs the work information registration process (Step S301). The information processing system 1 performs the work information registration process in response to a request from the system administrator. For example, the information processing apparatus 100 performs a process of registering the work information acquired from the system administrator terminal 10 in the work information storage unit 122 in response to the request from the system administrator terminal 10.

Furthermore, the information processing system 1 performs the learning model information registration process (Step S302). The information processing system 1 performs the learning model information registration process in response to a request from the system administrator. For example, the information processing apparatus 100 performs a process of registering the learning model information acquired from the system administrator terminal 10 in the learning model information storage unit 123 in response to the request from the system administrator terminal 10.

Furthermore, the information processing system 1 performs a learning model information sales registration process (Step S303). The information processing system 1 performs the learning model information sales registration process in response to a request from the system administrator. For example, the information processing apparatus 100 performs a process of registering the learning model information sold by the system administrator in the sales management information storage unit 124 in response to the request from the system administrator terminal 10.

[1-5-3. Browsing and Selecting Process of Shared List of Learning Model Information by General User]

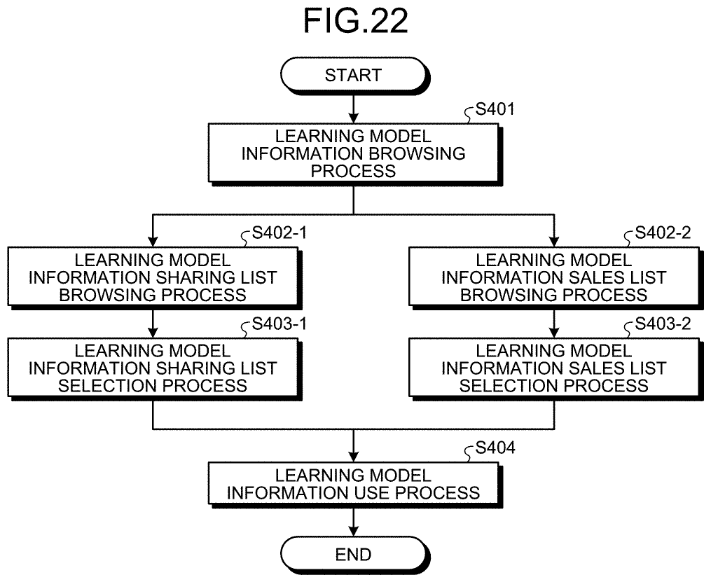

Next, a browsing and selecting process of a shared list of the learning model information by the general user will be described with reference to FIG. 22. FIG. 22 is a flowchart illustrating the information processing procedure according to the embodiment of the present disclosure. Specifically, FIG. 22 is a diagram (sequence diagram) illustrating the procedure of the browsing and selecting process of the shared list of the learning model information by the general user. Note that a process in each step illustrated in FIG. 22 may be performed by any device included in the information processing system 1, such as the information processing apparatus 100 or the terminal device (e.g., the general user terminal 30).

As illustrated in FIG. 22, the information processing system 1 performs the learning model information browsing process (Step S401). The information processing system 1 performs the learning model information browsing process in response to a request from the general user.

When the request of the general user is a browsing process of the learning model information sharing list, the information processing system 1 performs the learning model information sharing list browsing process (Step S402-1). For example, the information processing apparatus 100 performs a process of transmitting the list information of the learning model information to the general user terminal 30 in response to the shared list request from the general user terminal 30. When acquiring, from the general user terminal 30, the list browsing request of the learning model information that can be shared by the general user who uses the general user terminal 30, the information processing apparatus 100 provides, to the general user terminal 30, the list information of the learning model information that can be shared by the general user. Note that, when the information processing apparatus 100 acquires, from the general user terminal 30, the list browsing request of the learning model information created by the general user himself/herself who uses the general user terminal 30, the information processing apparatus 100 may provide the list information of the learning model information created by the general user himself/herself to the general user terminal 30. Furthermore, when acquiring, from the general user terminal 30, the list browsing request of the learning model information that has already been shared by the general user who uses the general user terminal 30, the information processing apparatus 100 may provide, to the general user terminal 30, the list information of the learning model information that has already been shared by the general user.

The information processing system 1 performs a selection process of the learning model information sharing list (Step S403-1). For example, when the general user selects the learning model information from the learning model information that can be shared by the general user, the information processing system 1 performs the selection process of the learning model information sharing list. When information indicating that the general user who uses the general user terminal 30 has selected the learning model information is acquired from the general user terminal 30, the information processing apparatus 100 registers the information indicating that the general user has shared the learning model information. For example, the information processing apparatus 100 registers information indicating that the general user has shared the learning model information in the shared information storage unit 125.

When the request of the general user is a browsing process of the sales list of the learning model information, the information processing system 1 performs the browsing process of the sales list of the learning model information (Step S402-2). For example, the information processing apparatus 100 performs a process of transmitting the list information of the learning model information to the general user terminal 30 in response to the sales list request from the general user terminal 30. The information processing apparatus 100 provides the list information of the learning model information for sale to the general user terminal 30.

The information processing system 1 performs a selection process of the sales list of the learning model information (Step S403-2). For example, the information processing system 1 performs the selection process of the sales list of the learning model information when the general user selects the learning model information from the learning model information for sale. When information indicating that the general user who uses the general user terminal 30 has selected the learning model information is acquired from the general user terminal 30, the information processing apparatus 100 registers the information indicating that the general user has purchased the learning model information. For example, the information processing apparatus 100 registers in the purchased information storage unit 126 the information indicating that the general user has purchased the learning model information.

The information processing system 1 performs a learning model information use process (Step S404). For example, the information processing apparatus 100 performs the learning model information use process in response to a use request of the learning model information from the general user terminal 30. The information processing system 1 provides a list of learning model information that can be used for learning by the general user who uses the general user terminal 30 in response to the use request of the learning model information from the general user terminal 30. The general user who uses the general user terminal 30 selects desired learning model information with reference to the meta information of learning model information or the like of the learning model information in the list. For example, the general user terminal 30 transmits information indicating the learning model information selected by the general user who uses the general user terminal 30 to the information processing apparatus 100. On the basis of the received information indicating the learning model information selected by the general user, the information processing apparatus 100 performs the use process such as composition using the learning model information selected by the general user. For example, such learning model information is the StylePallete of the AI-assisted composition system (information processing system 1), and the selected StylePallete is used for composition.

[1-5-4. Sale Consignment by Store Manager and Consignment Acceptance Process by System Administrator]

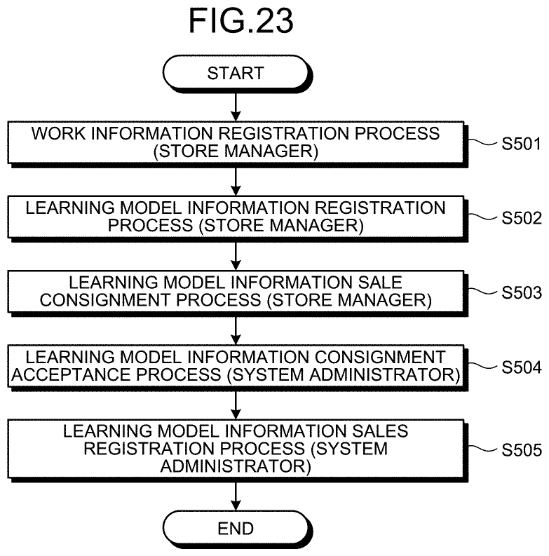

Next, a sale consignment by the store manager and a consignment acceptance process by the system administrator will be described with reference to FIG. 23. FIG. 23 is a flowchart illustrating the information processing procedure according to the embodiment of the present disclosure. Specifically, FIG. 23 is a diagram (sequence diagram) illustrating the learning model information registration and a sale consignment process by the store manager and the consignment acceptance and sale registration process by the system administrator. Note that a process in each step illustrated in FIG. 23 may be performed by any device included in the information processing system 1, such as the information processing apparatus 100 or the terminal device (e.g., the system administrator terminal 10 or the store manager terminal 20).

As illustrated in FIG. 23, the information processing system 1 performs the work information registration process (Step S501). The information processing system 1 performs the work information registration process in response to a request from the store manager. For example, the information processing apparatus 100 performs a process of registering the work information acquired from the store manager terminal 20 in the work information storage unit 122 in response to a request from the store manager terminal 20.

Furthermore, the information processing system 1 performs the learning model information registration process (Step S502). The information processing system 1 performs the learning model information registration process in response to the request from a store manager. For example, the information processing apparatus 100 performs a process of registering the learning model information acquired from the store manager terminal 20 in the learning model information storage unit 123 in response to the request from the store manager terminal 20.

In addition, the information processing system 1 performs a learning model information sale consignment process (Step S503). The information processing system 1 performs the learning model information sale consignment process in response to the request from the store manager. For example, the information processing apparatus 100 performs a process of notifying the system administrator terminal 10 of information indicating that sale of the learning model information has been consigned in response to the request from the store manager terminal 20.

In addition, the information processing system 1 performs a learning model information consignment acceptance process (Step S504). The information processing system 1 performs the learning model information registration process in response to a request from the system administrator. For example, the information processing apparatus 100 performs the learning model information consignment acceptance process according to a response from the system administrator terminal 10 to which the information indicating that the sale has been consigned has been notified. For example, when the information processing apparatus 100 receives the information indicating that the sale consignment is accepted from the system administrator terminal 10, the information processing apparatus 100 performs the learning model information consignment acceptance process.

Furthermore, the information processing system 1 performs a learning model information sales registration process (Step S505). The information processing system 1 performs the learning model information sales registration process according to the response from the system administrator. For example, when the information processing apparatus 100 receives information indicating acceptance of sale consignment from the system administrator terminal 10, the information processing apparatus 100 registers information indicating that the system administrator terminal 10 is consigned to sell the learning model of the store manager in the sales management information storage unit 124

[1-6. Conceptual Diagram of Configuration of Information Processing System]

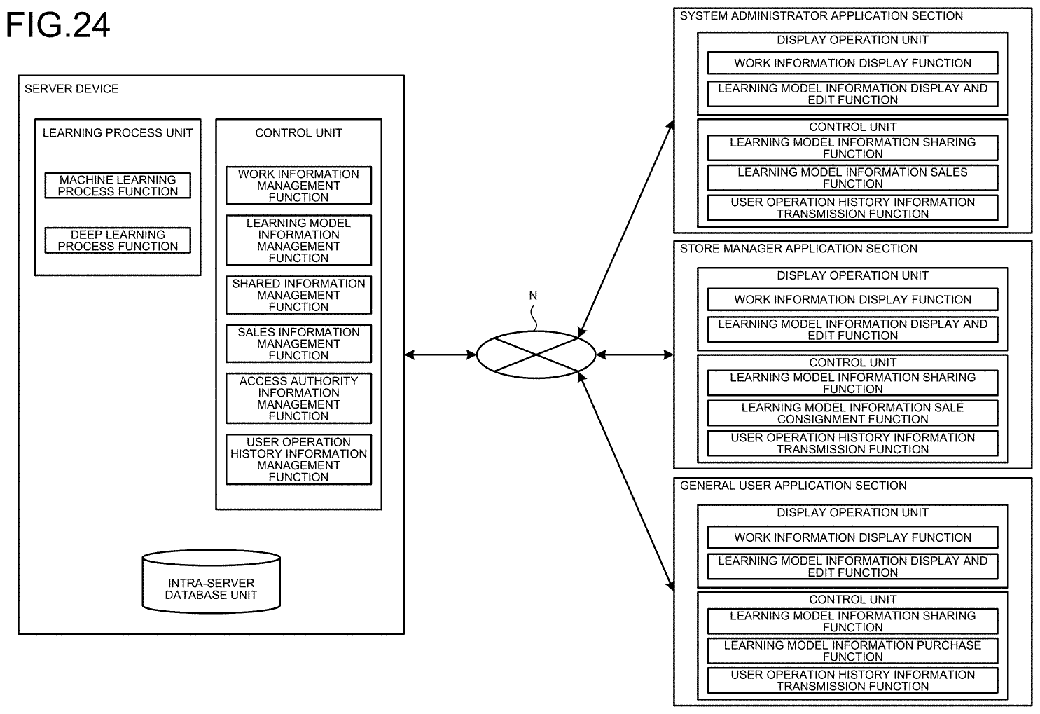

Here, each function, a hardware configuration, and data in the information processing system are conceptually illustrated with reference to FIG. 24. FIG. 24 is a diagram illustrating an example of a conceptual diagram of the configuration of the information processing system. Specifically, FIG. 24 is a schematic diagram illustrating an outline of functions of a learning model information sharing and selling system, which is an example of application of the information processing system 1.

[1-6-1. Overall Configuration]

The server device illustrated in FIG. 24 corresponds to the information processing apparatus 100 in the information processing system 1. A system administrator application section illustrated in FIG. 24 corresponds to the system administrator terminal 10 in the information processing system 1, and specifically corresponds to an application installed in the system administrator terminal 10. In addition, a store manager application section illustrated in FIG. 24 corresponds to the store manager terminal 20 in the information processing system 1, and specifically corresponds to an application installed in the store manager terminal 20. A general user application section illustrated in FIG. 24 corresponds to the general user terminal 30 in the information processing system 1, and specifically corresponds to an application installed in the general user terminal 30. In the example in FIG. 24, one store manager application section and one general user application section are illustrated, but a plurality of store manager application sections and a plurality of general user application sections may be included according to the number of corresponding store manager terminals 20 and general user terminals 30 (see FIG. 7).

The learning process unit and the control unit of the server device illustrated in FIG. 24 correspond to the control unit 130 of the information processing apparatus 100. For example, the learning process unit of the server device corresponds to the generation unit 132 of the information processing apparatus 100. An intra-server database unit of the server device corresponds to the storage unit 120 of the information processing apparatus 100.

The display operation unit and the control unit of the system administrator application section illustrated in FIG. 24 correspond to the control unit 15 of the system administrator terminal 10. For example, the display operation unit of the system administrator application section corresponds to the display operation unit 152 of the system administrator terminal 10.

The display operation unit and the control unit in the store manager application section illustrated in FIG. 24 correspond to the control unit 25 of the store manager terminal 20. For example, the display operation unit of the store manager application section corresponds to the display operation unit 252 of the store manager terminal 20.

The display operation unit and the control unit of the general user application section illustrated in FIG. 24 correspond to the control unit 35 of the general user terminal 30. For example, the display operation unit of store manager application section corresponds to the display operation unit 352 of the general user terminal 30.

Hereinafter, FIG. 24 will be described in more detail. For example, FIG. 24 is a schematic diagram illustrating the outline of the functions of the information processing system that is the learning model information sharing and selling system. As illustrated in FIG. 24, the server device is connected to the system administrator application section, the plurality of store manager application sections, and a plurality of general user application sections via the network N such as the Internet.

[1-6-2. Server Device]

First, a configuration related to the server device will be described.

The server device includes the control unit, the learning process unit, and the intra-server database unit. The control unit of the server device has a work information management function, a learning model information management function, a shared information management function, a sales information management function, an access authority information management function, and a user operation history information management function. The learning process unit of the server device has a machine learning process function and a deep learning process function.

For example, when the learning model information is registered in the intra-server database unit, a timing to store information in the learning result information may be calculated by the learning process unit (learning process function unit), and the result may be stored in the learning result information. In addition, a plurality of pieces of learning process result information may be collectively processed and stored in the learning process unit (learning process function unit) by nighttime batch processing or the like. In addition, in a case of a minor calculation, the calculation may be performed as needed at actually using the learning model information.

[1-6-3. System Administrator]

Next, a configuration related to the system administrator will be described.

The system administrator application section includes the display operation unit and the control unit. The display operation unit of the system administrator application section has a work information display function and a learning model information display and edit function. The control unit of the system administrator application section has a learning model information sharing function, a learning model information sales function, and a user operation history information transmission function.

The system administrator application section is, for example, music editing software (DAW or the like), and can display, for example, music information in the work information display function. When the DAW has, for example, an AI assisted music production function, it is possible to produce new music information while using the learning model information display and edit function.

The information to identify the system administrator is registered in the intra-server database unit, and the system administrator can register a new system administrator in the intra-server database unit using the access authority information management function via the network N from the display operation unit of the system administrator application section. The system administrator can register a special administrator (store manager) in the intra-server database unit using the access authority information management function via the display operation unit of the system administrator application section and the network N.

The system administrator can register the work information in the intra-server database unit using the work information display unit. The system administrator can register the learning model information in the intra-server database unit using the learning model information display and edit function. The system administrator gives an instruction to the shared information management function from the display operation unit, and can change the value of the sharing availability information of the learning model information from sharing disabled to sharing enabled.

The system administrator creates the sales management information using the sales information management function of the server device from the display operation unit via the network N. The sales management information includes a sales management information ID uniquely specifying each piece of the sales management information, the sales price information, the sales meta information, and the learning model information ID uniquely specifying each piece of the learning model information related to the sales management information.

After completing the registration of the sales management information, the system administrator changes the sales availability information corresponding to the learning model information from sale disabled to sale enabled by giving an instruction of sales registration completion to the sales information management function. For example, when the learning model information is registered, the value of the sales availability information of the learning model information shows sale disabled. The system administrator confirms sale consignment completion in the sales availability information corresponding to the learning model information, and gives an instruction of registration completion to the sales information management function, thereby changing the sales availability information corresponding to the learning model information from the sale consignment completion to sale enabled.

The system administrator uses the learning model information display and edit function to acquire the shared learning model information list from the shared information management function of the server device. For example, the system administrator can browse all items in the shared learning information list without a browsing restriction like the general user.

The system administrator uses the learning model display and edit function to acquire a list of sales enabled learning model information from the sales information management function of the server device. For example, the system administrator can browse all items in the sale enabled learning information list without purchasing like the general user.

An operation history of the system administrator is transmitted to the user operation history information management function of the server device via the network N by the user operation history information transmission function, and is stored as the user operation history list information.

[1-6-4. Store Manager]

Next, a configuration related to the store manager will be described.

The store manager application section includes the display operation unit and the control unit. The display operation unit of the store manager application section has a work information display function and a learning model information display and edit function. The control unit of the store manager application section has a learning model information sharing function, a learning model information sale consignment function, and a user operation history information transmission function.

The store manager application section is, for example, music editing software (DAW), and can display, for example, music information in the work information display function. When the DAW has, for example, an AI assisted music production function, it is possible to produce new music information while using the learning model information display and edit function.

The store manager can register the work information in the intra-server database unit using the work information display unit. The store manager can register the learning model information in the intra-server database unit using the learning model information display and edit function. The store manager gives an instruction to the shared information management function from the display operation unit, and can change the value of the sharing availability information of the learning model information from sharing disabled to sharing enabled.

The store manager creates the sales management information using the sales information management function of the server device from the display operation unit via the network N. When the store manager completes the registration of the sales management information, the store manager changes the sales availability information corresponding to the learning model information from the sale disabled to the sale consignment completion by giving an instruction of the consignment registration completion to the sales information management function.

By the operation of adding the learning model information ID to the shared bookmark list information, the store manager can register a favorite one from the acquired shared learning model information list as the store manager's own bookmark. The store manager can use the learning model information registered as the bookmark.

The store manager uses the learning model information display and edit function to acquire the shared learning model information list from the shared information management function of the server device. For example, the store manager has no browsing restriction like the general user, and can browse all items in the shared learning information list.

The store manager uses the learning model display and edit function to acquire the sale enabled learning model information list from the sales information management function of the server device. For example, the store manager can browse all items in the sale enabled learning information list without purchasing like the general user.

The operation history of the store manager is transmitted to the user operation history information management function of the server device via the network N by the user operation history information transmission function, and is stored as the user operation history list information.

[1-6-5. General User]

Next, a configuration related to the general user will be described.

The general user application section includes the display operation unit and the control unit. The display operation unit of the general user application section has a work information display function and a learning model information display and edit function. The control unit of the general user application section has a learning model information sharing function, a learning model information purchase function, and a user operation history information transmission function.

The general user application section is, for example, music editing software (DAW), and can display, for example, music information by the work information display function. When the DAW has, for example, an AI assisted music production function, it is possible to produce new music information while using the learning model information display and edit function.

The general user can use the access authority information management function from the display operation unit of the general user application section via the network N to register in the intra-server database unit by himself/herself. The general user creates the work information using the work information display unit, and the work information is registered in the intra-server database unit via the network N by the work information management function of the server device.

The general user can create the learning model information using the learning model information display and edit function to register the learning model information in the intra-server database unit via the network N by the learning model information management function of the server device.

The general user can change the state of the sharing availability information of the learning model information to share the learning model information by giving an instruction to the shared information management function of the server device from the display operation unit via the network N after agreeing, for example, with the terms of use. The sharing availability information can take, for example, a value indicating either sharing disabled (e.g., “0”) or sharing enabled (e.g., “1”). For example, the sharing availability information included in the learning model information at the time of registration of the learning model information is sharing disabled. Then, the general user gives instruction to the shared information management function to change the state of the sharing availability information corresponding to the learning model information to sharing enabled.

The general user can acquire a list of the learning model information associated with the creator ID indicating the general user himself/herself by making a request for browsing the list of the learning model information created by himself/herself to the learning model information management function of the server device via the network N from the learning model information display and edit function. The general user can display the list of the learning model information acquired from the server device by the learning model information display and edit function.

The general user makes a request for browsing a list of shared learning model information to the shared information management function of the server device via the network N by the learning model information display and edit function so that the general user can acquire the list of the learning model information whose sharing is enabled in the sharing availability information corresponding to the learning model information. The general user can display the list of the shared learning model information returned from the server device by the learning model information display and edit function.

The general user makes a shared bookmark request to the shared information management function of the server device via the network N from the learning model information display and edit function so that the learning model information ID is added to the shared bookmark list information. As a result, the general user can register a favorite from the acquired shared learning model information list as the bookmark of the general user himself/herself. In a bookmark registration process, a limit may be set to the number of bookmarks that can be registered. For example, when the number of pieces of learning model information shared by the user himself/herself is n (n is an arbitrary number), the upper limit of the learning model information that can be registered in the bookmark may be set to n×3 (three times the number of learning models provided by the user himself/herself). As a result, the information processing system can set a limit on the registrable number in the bookmark registration process of the shared information management function. Note that the upper limit is not limited to three times the number of learning models provided by the user himself/herself, and may be twice, five times, or the like.

The general user makes a request for browsing a list of sold learning model information to the sales information management function of the server device via the network N from the learning model information display and edit function, thereby acquiring a list of learning model information whose sales availability information corresponding to the learning model information is sales enabled. The general user can display the list of sales enabled learning model information returned from the server device by the learning model information display and edit function. The general user selects desired learning model information from the list of sales enabled learning model information, and requests the sales information management function to purchase the desired learning model information via the network N from the learning model information purchase function. When the general user completes payment according to the sales price information included in the sales management information related to the learning model information requested for purchase, the information processing system registers the learning model information ID that has been purchased in the user purchased list information. For example, the information processing system adds the learning model information ID for which the purchase has been completed to the user purchased list information associated with the information (user ID) that specifies the general user.

The general user makes a request for browsing a list of purchased learning model information to the sales information management function of the server device via the network N from the learning model information display and edit function, thereby acquiring the user purchased list information having the user ID of the general user himself/herself from the user purchased list information. As a result, the general user can acquire the list of the learning model information IDs included in the user purchased list information of the general user himself/herself so that the list of the purchased learning model information returned from the server device can be displayed by the learning model information display and edit function.

The general user selects desired learning model information from the acquired learning model information list while referring to the meta information of learning model information corresponding to the learning model information. The selected learning model information can be used by the learning process unit included in the server device. For example, the learning model information is a StylePallete of the AI-assisted composition system, and the selected StylePallete is used for composition in the learning process unit.

The operation history of the general user is transmitted to the user operation history information management function of the server device via the network N by the user operation history information transmission function, and is stored as the user operation history list information. The user operation history list information stored in the server device is used by the learning process unit, for example, and can be used to change a display sequence according to the preference of the user when the learning model list is transmitted to the user.

[1-6-6. Configuration and Effects]

The information processing system illustrated in FIG. 24 is the work management system including a user application having means for performing a display operation and control. The user application can communicate with the server device including a control means and an information storage means via a network means, and can transmit a plurality of pieces of work information to the server device via the network means. The plurality of pieces of transmitted work information includes a means for securely storing the work information in the server device.

The information processing system illustrated in FIG. 24 is the learning model information management system including a learning means by machine learning or deep learning in the server device. The information processing system is capable of learning the work information stored in the server device, and includes a means for storing the learning model information, which is a plurality of datasets used for learning, in the server device.

The information processing system illustrated in FIG. 24 includes an access authority information management means in the server device that can identify the system administrator, the store manager, and the general user as the authority of the user, and performs processing according to each authority.

The information processing system illustrated in FIG. 24 includes a shared information management means that controls sharing of the learning model information in the server device, and enables the user to share the learning model information.

In the information processing system illustrated in FIG. 24, the shared information management means included in the server device is the learning model information sharing system that enables a part of the shared learning model information to be bookmarked.

The shared information management means included in the server device illustrated in FIG. 24 is capable of managing the number of pieces of learning model information shared by the general user and the number of bookmarks, and includes a means capable of controlling the number of pieces of information that the general user can bookmark according to the number of pieces of shared information.

The shared information management means included in the server device illustrated in FIG. 24 includes a means that allows the system administrator and the store manager to use the learning model information shared without limitation in the number of pieces.

The information processing system illustrated in FIG. 24 includes a sales information management means that controls sale of the learning model information in the server device, and enables the system administrator to sell the learning model information.

In the information processing system illustrated in FIG. 24, the store manager can consign sale of the learning model information to the system administrator by the sales information management means included in the server device, and the system administrator can sell the learning model information consigned by the store manager.

The information processing system illustrated in FIG. 24 is the learning model information sharing and selling system capable of making the shared and sold learning model information available based on permission according to the authority of each user.

The information processing system illustrated in FIG. 24 is the learning model information sharing and selling system capable of registering a bundle product having a plurality of pieces of learning model information in one product.

The information processing system illustrated in FIG. 24 includes a means that records the operation history of the user in the server device, and enables the operation record to be used for learning.

The user can communicate with the server device via the network from the user application section, and register a plurality of pieces of work information in the intra-server database unit by the work information management function of the server device. These pieces of work information are securely protected by the work information management function, and can be prevented from being browsed by other users.

The user can be classified into the system administrator, the store manager, and the general user according to each authority.

The user can register a plurality of pieces of learning model information using the work information registered in the intra-server database unit by the learning model information management function of the server device.

The user can individually set whether or not to share the learning model information registered by the user himself/herself in the intra-server database unit by the shared information management function of the server device. At the time when the learning model information is registered in the intra-server database unit, the learning model information cannot be shared, and the user can change to sharing enabled by the shared information management function.

When the learning model information is changed to sharing enabled, the general user agrees to permit the use of the learning model information by all the users. As a result, the system administrator can freely use the learning model information of the general user.

The system administrator can individually set whether or not to sell the learning model information registered by the system administrator in the intra-server database unit by the sales information management function of the server device. At the time when the learning model information is registered in the intra-server database unit, the learning model information cannot be sold, and the system administrator can add the sales management information by the sales information management function and change the learning model information to sale enabled.

The information processing system can register a so-called bundle product having the plurality of pieces of learning model information 123 in one piece of sales management information 124.

In the information processing system, the store manager can individually set whether or not to consign selling of the learning model information registered by the store manager in the intra-server database unit by the sales information management function of the server device. At the time when the learning model information is registered in the intra-server database unit, the learning model information is consignment disabled, and the store manager can add the sales management information by the sales information management function and change the learning model information to the sale consignment completed.

The information processing system can consign the bundle product having the plurality of pieces of learning model information in one piece of sales management information.

The system administrator can change the learning model information from the sale consignment completed state to the sales enabled state by confirming that the learning model information is in the sale consignment completed state and giving an instruction of registration completed to the sales information management function.

The general user can acquire a list of the learning model information created by himself/herself by making a request for browsing a list of learning model information created by himself/herself to the learning model information management function of the server device.

The general user and the store manager can acquire a list of learning model information that can be shared by making a request for the list of shared learning model information to the shared information management function of the server device. The store manager can use all pieces of the learning model information that can be shared without limitation.

The general user can perform the bookmark registration of the learning model information by making a request for bookmark registration of the preferred learning model information to the shared information management function of the server device. The general user can use only the bookmarked learning model information.

In a case where the number of pieces of learning model information shared by the general user is n, the information processing system can limit the number of pieces of learning model information that can be bookmarked by the general user, such as up to n×3 bookmarks.

The general user and the store manager can acquire a list of the sales enabled learning model information by making a request for the list of the sales enabled learning model information to the sales information management function of the server device.

In the information processing system, the general user can purchase desired learning model information by making a request for purchase of the desired learning model information to the sales information management function of the server device, and completing payment according to the sales price information corresponding to the sales management information related to the desired learning model information.

The general user can acquire a list of purchased learning model information by making a request for the list of purchased learning model information to the sales information management function of the server device.

The general user can obtain a list of currently available learning model information. The general user can select desired learning model information from the meta information of learning model information corresponding to the learning model information, and use the learning process unit of the server device.

The store manager can obtain the list of currently available learning model information. The store manager can select desired learning model information from the meta information of learning model information corresponding to the learning model information, and use the learning process unit of the server device.

The learning process unit may be used at the time when the learning model information is generated, may be used at the time of batch processing such as at nighttime, or may be processed at any time when the learning model information is selected.

In the information processing system, the user operation history is transmitted to the user operation history information management function of the server device, and is stored in the intra-server database unit as the user operation history information.

The information processing system can use the user operation history information for the process in the learning process unit.

[1-7. User Interface (UI)]

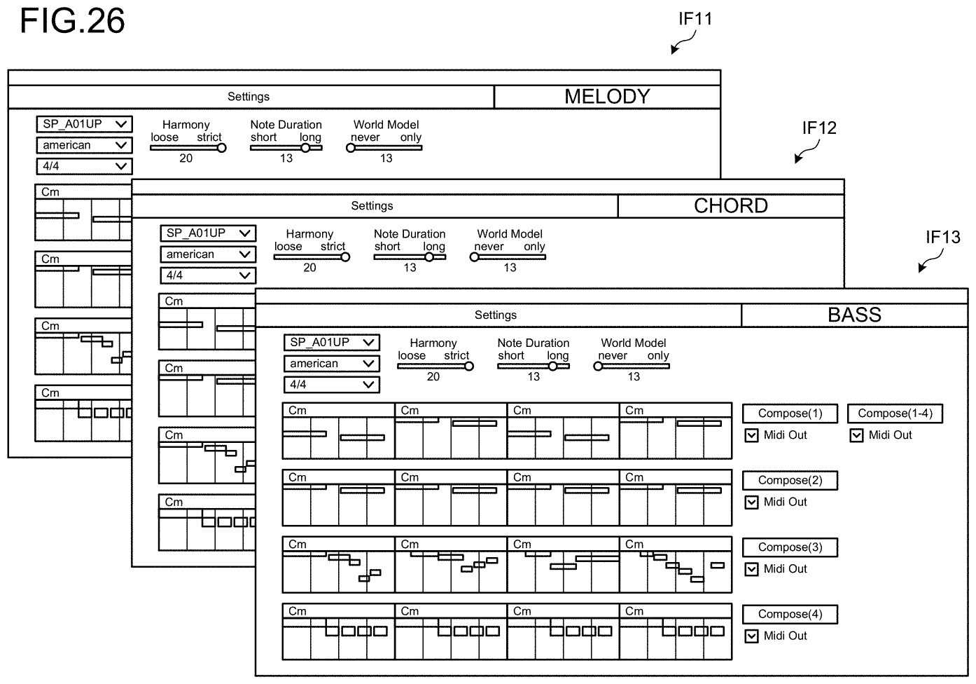

Here, details of the automatic composition function including information display by the application (music creation application) will be described with reference to FIGS. 25 and 26. FIGS. 25 and 26 are diagrams illustrating an example of the user interface according to the embodiment.

FIG. 25 illustrates an example of the user interface when the music creation application is displayed on a screen of the user terminal 10.

In the example illustrated in FIG. 25, the user interface IF11 displays music data received by the music creation application. Note that, although details will be described later, the music data in the music creation application includes three types of different data of melody, chord, and bass sound. The user interface IF11 illustrated in FIG. 25 displays data related to the melody in the three types of different data.

Setting information ST11 displays information regarding the StylePallete that is an example of the setting information in the automatic composition function. The StylePallete is designation information for designating material music that will be learning data for machine learning.

Setting information ST12 displays harmony information that is an example of the setting information in the automatic composition function. The harmony information is, for example, information for determining a probability that a constituent sound included in the chord appears in the melody in music data composed by the processing server 100. For example, when the user sets the harmony information to “strict”, the probability that the constituent sound included in the chord appears in the melody in the automatically composed music data increases. On the other hand, when the user sets the harmony information to “loose”, the probability that the constituent sound included in the chord appears in the melody in the automatically composed music data is lowered. The example in FIG. 25 indicates that the user applies “strict” to the harmony information.

Setting information ST13 displays note duration information that is an example of the setting information in the automatic composition function. The note duration information is, for example, information for determining the note duration in the music data composed by the processing server 100. For example, when the user sets the note duration information to “long”, the probability that the note with a relatively long duration of sound to be produced (e.g., a whole note and half note) appears in the automatically composed music data increases. On the other hand, when the user sets the note duration information to “short”, the probability that the note with relatively short duration of sound be produced (e.g., eighth note and sixteenth note) appears in the automatically composed music data increases.

Setting information ST14 displays information for determining a type and amount of material music other than the material music included in the designation information (the StylePallete designated by the user), which is an example of the setting information in the automatic composition function. This information is, for example, information for determining whether or not to strictly perform learning on the basis of music included in the StylePallete designated by the user in the music data composed by the processing server 100. For example, when the user sets this information to “never”, music other than the music included in the StylePallete is less likely to be used in the learning in the automatic composition. On the other hand, when the user sets this information to “only”, music other than the music included in the StylePallete is more likely to be used in the learning in the automatic composition.

Music data MDT1 shows specific music data transmitted from the processing server 100. In the example in FIG. 25, the music data MDT1 includes information indicating chord progression such as Cm, information indicating a pitch in a bar or a note duration, transition of a note pitch (in other words, melody), and the like. Furthermore, as illustrated in FIG. 25, the music data MDT1 may include, for example, four types of different content. In other words, the processing server 100 may transmit a plurality of pieces of music data instead of transmitting only one type as the automatically composed music data. As a result, the user can select his/her favorite music data from candidates of the plurality of pieces of music data generated, or compose a favorite music by combining the plurality of pieces of music data.

Note that the user interface IF11 illustrated in FIG. 25 displays data related to the melody among three types of different data that is the melody, the chord, and the bass sound included in the music data, but other data is displayed on other user interfaces. This point will be described with reference to FIG. 26.

As illustrated in FIG. 26, in addition to the user interface IF11 that shows the data related to the melody, the user terminal 10 may display the user interface IF12 that shows the data related to the chord and the user interface IF13 that shows the data related to the bass sound on the screen. Although not illustrated in FIG. 26, note information different from the music data MDT1 in the user interface IF11 is shown in the user interface IF12 and the user interface IF13. Specifically, the note information (e.g., constituent sound of chord Cm) related to the chord corresponding to the melody of music data is displayed in the user interface IF12. Further, the note information (e.g., for the chord Cm, the “C” sound) related to the bass sound corresponding to the melody or the chord of music data is shown in the user interface IF13.

The user can select information to be copied from the user interface IF11, the user interface IF12, and the user interface IF13 displayed, and for example, perform a work such as editing a part of the bass sound.

[1-8. Information Display] The terminal devices such as the system administrator terminal 10, the store manager terminal 20, and the general user terminal 30 may display various types of information. This point will be described with reference to FIGS. 27 to 30.

[1-8-1. Screen Example of List of Created Music Score Data]

First, display of a list of created music score data will be described with reference to FIG. 27. FIG. 27 is a diagram illustrating an example of displayed information. Specifically, FIG. 27 is a diagram illustrating an example of a screen of the list of created music score data. In FIG. 27, a case where the general user terminal 30 used by a user #001 displays information will be described as an example.

In the example in FIG. 27, the image IM11 displaying the list of created music score data is illustrated as an example. The general user terminal 30 displays the image IM11 indicating the music score data created by the user #001. The general user terminal 30 displays the list of information indicating the plurality of pieces of music score data such as titles #001 to #015 created by the user #001. The user #001 edits or deletes the music score data corresponding to each title by operating an editing button indicated as “Edit” or a deletion button indicated as “Delete” displayed on the right side of each title. Further, the user #001 adds the music score data by operating an adding button indicated as “Add”. In this manner, the user adds, edits, or deletes the music score data by performing an operation on the image IM11.

[1-8-2. Screen Example for Creating StylePallete]

Next, a display of the list of the created music score data will be described with reference to FIG. 28. FIG. 28 is a diagram illustrating an example of displayed information. Specifically, FIG. 28 is a diagram illustrating a screen example for creating the StylePallete. In FIG. 28, a case where the general user terminal 30 displays information will be described as an example.

FIG. 28 is an example illustrating the image IM21 displaying information for creating the StylePallete. The general user terminal 30 displays the image IM21 including a field (form) in which the user inputs information for creating the StylePallete. The general user terminal 30 displays the image IM21 including a field for inputting a name of the StylePallete corresponding to [name] at the top, the field for inputting a creator corresponding to [author] in the field below, and the like. In addition, the column of [StylePallete] includes items such as tempo, atmosphere, structure, chord progression, and mode. The tempo is information indicating a tempo of the music, and an up tempo (up), a slow tempo (slow), or the like is input. The atmosphere is information indicating an atmosphere of the music, and cheerful (plus), gloomy (minus), or the like is input. The structure is information indicating a structure of the music, and a structure #001, a structure #002, and the like are input. Note that, in the example in FIG. 28, the structure is indicated by a character string such as the structure #001, but any information may be used as long as the structure can be specified. For example, the structure may be information such as “bars A” or “bars B”. The chord progression is information indicating chord progression of the music, and chord progression #001 or the like is input. In the example in FIG. 28, the chord progression is indicated by a character string such as chord progression #001, but any information may be used as long as the chord progression can be specified. For example, the chord progression may be information specifically indicating the chord progression, for example, “F-C-B-E” or “C-Am-F-G”. The mode is information indicating a mode of the music, and a mode #001, a mode #002, and the like are input. In the example in FIG. 28, the mode is indicated by a character string such as the mode #001, but any information may be used as long as the mode can be specified. For example, the mode may be information specifically indicating a mode based on music theory. The mode may be, for example, information such as “Dorian”, “Phrygian”, “Lydian”, “Mixolydian”, “Aeolian”, or “Locrian”.

Furthermore, the general user terminal 30 displays the image IM21 including a field to designate a music score (data) that will be an element of the StylePallete corresponding to [element] at the bottom, and the like. In the [element], the title corresponding to each piece of music (music score), the author, and data (a hash value or the like) obtained by encoding (encrypting) predetermined data are displayed. The user #001 selects or deletes the music score data corresponding to each element by operating a selection button indicated as “Select Songs” or a deletion button indicated as “Delete Row” displayed on the right side of each element in the [element]. In this manner, the user performs an operation on the image IM21 to input various types of information, select music score data, or cancel the selected music score data. Information on items such as the tempo, the atmosphere, the structure, the chord progression, and the mode in the column of [StylePallete] may be input by the user such as the general user, or may be automatically input by the terminal device such as the general user terminal 30. For example, in a case where the general user terminal 30 automatically inputs information, the general user terminal 30 may generate information to be input to items such as the tempo, the atmosphere, the structure, the chord progression, and the mode on the basis of information on the music (music score) registered in [element]. For example, the general user terminal 30 may generate information to be input to the item of tempo on the basis of the tempo of the music (music score) registered in [element]. When the tempo of the music (music score) registered in the [element] is the slow tempo, the general user terminal 30 inputs “slow” in the item of tempo.

[1-8-3. Example of Screen Displaying List of Sales-Registered StylePalletes]

Next, a display of a list of created music score data will be described with reference to FIG. 29. FIG. 29 is a diagram illustrating an example of displayed information. Specifically, FIG. 29 is a diagram illustrating an example of a screen displaying a list of sales-registered StylePalletes. In FIG. 29, a case where the general user terminal 30 used by the user #001 displays information will be described as an example.

FIG. 29 illustrates an example of the image IM31 displaying the list of sales-registered StylePalletes. The general user terminal 30 displays the image IM31 including the list of sales-registered StylePalletes. The general user terminal 30 displays the list including the StylePallete (StylePallete SP #001) whose name is “SP #001” and whose creator is “user #001”. The StylePallete SP #001 has the “up” tempo, the “plus” atmosphere, the “structure #002” structure, the “chord progression #005” chord progression, and the “mode #001” mode. The user edits or deletes the StylePallete by operating the editing button indicated as “Edit” or the deletion button indicated as “Delete” displayed on the right side of each of the StylePallete. In addition, the user adds the StylePallete by operating the adding button indicated as “Add”. In this manner, the user adds, edits, or deletes the StylePallete by performing the operation on the image IM31.

[1-8-4. Example of Screen Displaying List of Self-Managed StylePalletes]

Next, a display of a list of created music score data will be described with reference to FIG. 30. FIG. 30 is a diagram illustrating an example of displayed information. Specifically, FIG. 30 is a diagram illustrating an example of a screen displaying a list of self-managed StylePalletes. FIG. 30 illustrates the example of a case where the general user terminal 30 displays the information will be described.

FIG. 30 illustrates the example of the image IM41 displaying information for managing the StylePallete. The general user terminal 30 displays the list of StylePalletes. The general user terminal 30 may display the list of StylePalletes self-managed by the user who uses the general user terminal 30. For example, the list of StylePalletes illustrated in the image IM41 may include StylePalletes created by the user himself/herself, bookmarked StylePalletes, and purchased StylePalletes.

### 2. Other Embodiments

The processes according to the above-described embodiments and modifications may be performed in various different forms (modifications) other than the above-described embodiments and modifications.

[2-1. Other Configuration Examples]

Each of the above-described configurations is an example, and the information processing system 1 may have any system configuration as long as the above-described information processing can be realized. For example, the information processing apparatus 100 and the system administrator terminal 10 may be integrated. For example, the system administrator terminal 10 may be an information processing apparatus having the function of the information processing apparatus 100.

[2-2. Others]

Among the processes described in the above embodiments, all or part of the processes described as being performed automatically can be performed manually, or all or part of the processes described as being performed manually can be performed automatically by a known method. In addition, the processing procedure, specific name, and information including various data and parameters illustrated in the document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. In other words, a specific form of distribution and integration of each device is not limited to the illustrated form, and all or a part thereof can be functionally or physically distributed and integrated in an arbitrary unit according to various loads, usage conditions, and the like.

In addition, the above-described embodiments and modifications can be appropriately combined within a range not contradicting the processes.

Note that the effects described in the present specification are merely examples and not limited, and other effects may be provided.

### 3. Effects According to Present Disclosure

As described above, the information processing apparatus (the information processing apparatus 100 in the embodiment) according to the present disclosure includes a generation unit (the generation unit 132 in the embodiment) and a determination unit (the determination unit 133 in the embodiment). The generation unit generates a model regarding content generation by using the data provided by the service user subject having one authority level among the plurality of authority levels of the service regarding the content creation. The determination unit determines the usage mode of the model generated by the generation unit according to the one authority level of the user subject.

As a result, the information processing apparatus according to the present disclosure can appropriately determine the usage mode of the model according to which authority level is assigned to the model based on the data of the subject, by determining the usage mode of the model depending on the data provided by which subject is used for generating the model. Therefore, the information processing apparatus is capable of appropriately using the model according to the data used for generating the model.

In addition, the determination unit determines the use range of the model in the service according to the one authority level. As a result, the information processing apparatus determines the use range of the model in the service according to the one authority level, so that the use range can be appropriately determined according to which authority level is assigned to the model based on the data of the subject. Therefore, the information processing apparatus is capable of appropriately using the model according to the data used for generating the model.

In addition, the determination unit determines whether or not the model can be sold or shared according to the one authority level. As a result, the information processing apparatus determines whether or not the model can be sold or shared according to the one authority level, so that the information processing apparatus can appropriately determine whether or not the model can be sold or shared according to which authority level is assigned to the model based on the data of the subject. Therefore, the information processing apparatus is capable of appropriately using the model according to the data used for generating the model.

In addition, the generation unit generates a model by using the data provided by the user subject having one authority level among the plurality of authority levels including the first authority level given to the service administrator, the second authority level given to the seller that sells the service, and the third authority level given to a general user who uses the service. The determination unit determines that the model can be used in the service corresponding to the first authority level when the one authority level possessed by the user subject is the first authority level, determines that the model can be used in the service corresponding to the second authority level when the one authority level possessed by the user subject is the second authority level, and determines that the model can be used in the service corresponding to the third authority level when the one authority level possessed by the user subject is the third authority level. As a result, the information processing apparatus can generate the model using the data of the subject to which one of the first authority level to the third authority level is assigned, and can appropriately determine the use range according to which authority level is assigned to the model based on the data of the subject. Therefore, the information processing apparatus is capable of appropriately using the model according to the data used for generating the model.

The generation unit generates the model using the data provided by the user subject having one of the plurality of authority levels including the second authority level whose authority is limited more than the first authority level and the third authority level whose authority is limited more than the second authority level. As a result, the information processing apparatus can generate the model by using the data of the subject to which one of the first authority level to the third authority level, whose authorized content is limited according to the authority level, is assigned. Then, the information processing apparatus can appropriately determine the use range according to which authority level is assigned to the model based on the data of the subject. Therefore, the information processing apparatus is capable of appropriately using the model according to the data used for generating the model.

In addition, the generation unit generates the model by using the data provided by the user subject having one of the plurality of authority levels including the first authority level that can accept sale consignment from the user subject having the second authority level. As a result, the information processing apparatus enables the user subject having the first authority level to sell the model generated using the data of the subject having the second authority level, thereby enabling the appropriate use of the model according to the data used for generating the model.

In addition, the generation unit generates the model by using the data provided by the user subject having one of the plurality of authority levels including the second authority level that can sell and share the model generated by the data of the user subject having the second authority level. As a result, the information processing apparatus enables the subject to both sell and share the model generated using the data of the subject having the second authority level, thereby enabling the appropriate use of the model according to the data used for generating the model.

In addition, the generation unit generates the model by using the data provided by the user subject having one of the plurality of authority levels including the third authority level with which the model generated by the data of the user subject having the third authority level can be shared. As a result, the information processing apparatus enables the subject only to share the model generated using the data of the subject having the third authority level, thereby enabling the appropriate use of the model according to the data used for generating the model.

The generation unit generates the meta information corresponding to the model based on the data provided by the user subject. As a result, the information processing apparatus can confirm the content of the model by generating the meta information corresponding to the model, and can promote the use of the model. Therefore, the information processing apparatus is capable of appropriately using the model according to the data used for generating the model.

Furthermore, the information processing apparatus includes a transmission unit (the transmission unit 134 in the embodiment). The transmission unit transmits the model to the terminal device used by the user subject. As a result, the information processing apparatus can confirm the model generated by the user subject providing the data by transmitting the model to the terminal device used by the user subject.

Furthermore, the information processing apparatus includes an acceptance unit (the acceptance unit 135 in the embodiment). The acceptance unit accepts data from the user subject. As a result, the information processing apparatus can generate the model using the data accepted from the user subject.

In addition, the generation unit generates a model at a timing when the acceptance unit accepts the data. The transmission unit transmits the model to the terminal device at a timing when the generation unit generates the model. As a result, the information processing apparatus can accept the data from the certain subject, generate a model, and provide the model to the subject at the generated timing. In this manner, the information processing apparatus can provide the model to the data provider in a short time by generating the model and providing the model at the timing when there is a model generation request from a certain subject.

In addition, the determination unit determines information to be provided to one user subject on the basis of the service use history of the one user subject. As a result, the information processing apparatus can provide appropriate information according to the user subject by determining information to be provided to the one user subject on the basis of the service use history of the one user subject.

In addition, the determination unit determines the plurality of models to provide information to the one user subject. The generation unit generates information on the list of the plurality of models determined by the determination unit. As a result, the information processing apparatus generates the information on the list of the plurality of models to be provided with information to the one user subject, thereby making it possible to provide the information of the model to the one user subject, and promoting the use of the model by the one user subject.

In addition, the determination unit determines a recommended model recommended to be used by one user subject among the plurality of models. As a result, the information processing apparatus determines the recommended model recommended to be used by the one user subject among the plurality of models, thereby making it possible to recommend the use of the model to the one user subject, and promoting the use of the model by the one user subject.

In addition, the generation unit generates a model regarding music generation by using data provided by the user subject having one of the plurality of authority levels of the service regarding creation of music, which is content. As a result, the information processing apparatus can appropriately determine the usage mode of the model according to the authority level of the service assigned related to creation of the music, which is the content, based on the data of the subject to which the authority level is assigned. Therefore, the information processing apparatus is capable of appropriately using the model in the service related to creation of music, which is content, according to the data used for generating the model.

Furthermore, the information processing apparatus includes a providing unit (the providing unit 136 in the embodiment). The providing unit provides the music listening service. As a result, the information processing apparatus can confirm in advance what kind of music will be generated before purchasing and sharing the model, so that a satisfaction level of the user can be improved and the use of the model can be promoted.

Furthermore, the providing unit provides the music listening service generated when the model is used. As a result, the information processing apparatus can confirm in advance what kind of music is to be generated by using the model, so that the satisfaction level of the user can be improved and the use of the model can be promoted.

### 4. Hardware Configuration

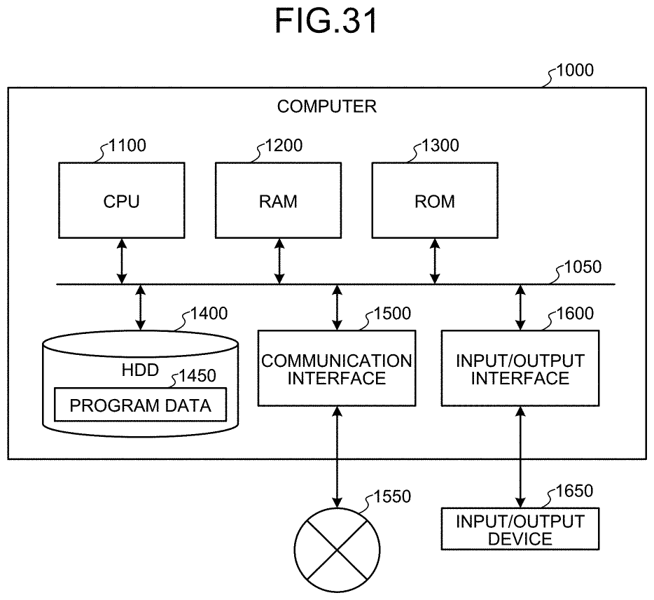

The information apparatuses such as the information processing apparatus 100, the system administrator terminal 10, the store manager terminal 20, and the general user terminal 3050 according to the above-described embodiments and modifications are realized, for example, by a computer 1000 having a configuration as illustrated in FIG. 31. FIG. 31 is a hardware configuration diagram illustrating the example of the computer 1000 that implements the functions of the information processing apparatus such as the information processing apparatus 100, the system administrator terminal 10, the store manager terminal 20, and the general user terminal 30. Hereinafter, the information processing apparatus 100 according to the embodiment will be described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program dependent on hardware of the computer 1000, and the like.

The HDD 1400 is a computer-readable recording medium that non-transiently records a program executed by the CPU 1100, data used by the program, and the like. Specifically, the HDD 1400 is a recording medium that records the information processing program according to the present disclosure, which is an example of program data 1450.

The communication interface 1500 is an interface for the computer 1000 to connect to an external network 1550 (for example, the Internet). For example, the CPU 1100 receives data from another apparatus or transmits data generated by the CPU 1100 to another apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 100 according to the embodiment, the CPU 1100 of the computer 1000 implements the functions of the control unit 130 and the like by executing the information processing program loaded on the RAM 1200. In addition, the HDD 1400 stores the information processing program according to the present disclosure and the data in the storage unit 120. Note that the CPU 1100 reads the program data 1450 from the HDD 1400 and executes the program data, but as another example, these programs may be acquired from another device via the external network 1550.

Note that the present technology can also have the following configurations.

(1)

An information processing apparatus comprising:

a generation unit that generates a model regarding generation of content by using data provided by a user subject of a service regarding creation of the content, the user subject having one authority level among a plurality of authority levels of the service; and

a determination unit that determines a usage mode of the model generated by the generation unit according to the one authority level of the user subject.

(2)

The information processing apparatus according to (1), wherein

the determination unit

determines a use range of the model in the service according to the one authority level.

(3)

The information processing apparatus according to (1) or (2), wherein

the determination unit

determines sales or sharing possibility of the model according to the one authority level.

(4)

The information processing apparatus according to any one of (1) to (3), wherein

the generation unit

generates the model by using the data provided by the user subject having the one authority level among the plurality of authority levels including a first authority level given to an administrator of the service, a second authority level given to a seller that conducts sales in the service, and a third authority level given to a general user that uses the service, and

the determination unit

determines that the model can be used in the service corresponding to the first authority level when the one authority level of the user subject is the first authority level, determines that the model can be used in the service corresponding to the second authority level when the one authority level of the user subject is the second authority level, and determines that the model can be used in the service corresponding to the third authority level when the one authority level of the user subject is the third authority level.

(5)

The information processing apparatus according to (4), wherein

the generation unit

generates the model by using the data provided by the user subject having the one authority level among the plurality of authority levels including the second authority level whose authority is limited more than the first authority level and the third authority level whose authority is limited more than the second authority level.

(6)

The information processing apparatus according to (4) or (5), wherein

the generation unit

generates the model by using the data provided by the user subject having the one authority level among the plurality of authority levels including the first authority level that can accept sale consignment from the user subject having the second authority level.

(7)

The information processing apparatus according to any one of (4) to (6), wherein

the generation unit

generates the model by using the data provided by the user subject having the one authority level among the plurality of authority levels including the second authority level that can sell and share a model generated by using data of the user subject having the second authority level.

(8)

The information processing apparatus according to any one of (4) to (7), wherein

the generation unit

generates the model by using the data provided by the user subject having the one authority level among the plurality of authority levels including the third authority level that can share a model generated by using data of the user subject having the third authority level.

(9)

The information processing apparatus according to any one of (1) to (8), wherein

the generation unit

generates meta information corresponding to the model according to the data provided by the user subject.

(10)

The information processing apparatus according to any one of (1) to (9), further comprising

a transmission unit that transmits the model to a terminal device used by the user subject.

(11)

The information processing apparatus according to (10), further comprising

an acceptance unit that accepts the data from the user subject, wherein

the generation unit generates the model in response to acceptance of the data by the acceptance unit.

(12)

The information processing apparatus according to (11), wherein

the generation unit

generates the model at a timing that the acceptance unit accepts the data, and

the transmission unit

transmits the model to the terminal device at a timing that the generation unit generates the model.

(13)

The information processing apparatus according to any one of (1) to (12), wherein

the determination unit

determines information to be provided to one user subject according to a history of using the service by the one user subject.

(14)

The information processing apparatus according to (13), wherein

the determination unit

determines a plurality of models, information of the plurality of models being provided to the one user subject, and

the generation unit

generates list information of the plurality of models determined by the determination unit.

(15)

The information processing apparatus according to (13) or (14), wherein

the determination unit

determines a recommended model among a plurality of models, a use of the recommended model being recommended to the one user subject.

(16)

The information processing apparatus according to any one of (1) to (15), wherein

the generation unit

generates the model regarding generation of music by using the data provided by the user subject having the one authority level among the plurality of authority levels of the service regarding creation of the content, the content being the music.

(17)

The information processing apparatus according to (16), further comprising

a providing unit that provides a listening service of the music.

(18)

The information processing apparatus according to (17), wherein

the providing unit

provides the listening service of the music generated when the model is used.

(19)

An information processing method executed by a computer, the method comprising:

generating a model regarding generation of content by using data provided by a user subject of a service regarding creation of the content, the user subject having one authority level among a plurality of authority levels of the service; and

determining a usage mode of the model generated according to the one authority level of the user subject.

(20)

An information processing program causing a computer to execute:

generating a model regarding generation of content by using data provided by a user subject of a service regarding creation of the content, the user subject having one authority level among a plurality of authority levels of the service; and

determining a usage mode of the model generated according to the one authority level of the user subject.

### REFERENCE SIGNS LIST

1 INFORMATION PROCESSING SYSTEM
100 INFORMATION PROCESSING APPARATUS
110 COMMUNICATION UNIT
120 STORAGE UNIT
121 USER INFORMATION STORAGE UNIT
122 WORK INFORMATION STORAGE UNIT
123 LEARNING MODEL INFORMATION STORAGE UNIT
124 SALES MANAGEMENT INFORMATION STORAGE UNIT
125 SHARED INFORMATION STORAGE UNIT
126 PURCHASED INFORMATION STORAGE UNIT
127 OPERATION HISTORY INFORMATION STORAGE UNIT
130 CONTROL UNIT
131 ACQUISITION UNIT
132 GENERATION UNIT
133 DETERMINATION UNIT
134 TRANSMISSION UNIT
135 ACCEPTANCE UNIT
136 PROVIDING UNIT
10 SYSTEM ADMINISTRATOR TERMINAL
20 STORE MANAGER TERMINAL
30 GENERAL USER TERMINAL

1. An information processing apparatus comprising:
a generation unit that generates a model regarding generation of content by using data provided by a user subject of a service regarding creation of the content, the user subject having one authority level among a plurality of authority levels of the service; and
a determination unit that determines a usage mode of the model generated by the generation unit according to the one authority level of the user subject.

2. The information processing apparatus according to claim 1, wherein
the determination unit
determines a use range of the model in the service according to the one authority level.

3. The information processing apparatus according to claim 1, wherein
the determination unit
determines sales or sharing possibility of the model according to the one authority level.

4. The information processing apparatus according to claim 1, wherein
the generation unit
generates the model by using the data provided by the user subject having the one authority level among the plurality of authority levels including a first authority level given to an administrator of the service, a second authority level given to a seller that conducts sales in the service, and a third authority level given to a general user that uses the service, and
the determination unit
determines that the model can be used in the service corresponding to the first authority level when the one authority level of the user subject is the first authority level, determines that the model can be used in the service corresponding to the second authority level when the one authority level of the user subject is the second authority level, and determines that the model can be used in the service corresponding to the third authority level when the one authority level of the user subject is the third authority level.

5. The information processing apparatus according to claim 4, wherein
the generation unit
generates the model by using the data provided by the user subject having the one authority level among the plurality of authority levels including the second authority level whose authority is limited more than the first authority level and the third authority level whose authority is limited more than the second authority level.

6. The information processing apparatus according to claim 4, wherein
the generation unit
generates the model by using the data provided by the user subject having the one authority level among the plurality of authority levels including the first authority level that can accept sale consignment from the user subject having the second authority level.

7. The information processing apparatus according to claim 4, wherein
the generation unit
generates the model by using the data provided by the user subject having the one authority level among the plurality of authority levels including the second authority level that can sell and share a model generated by using data of the user subject having the second authority level.

8. The information processing apparatus according to claim 4, wherein
the generation unit
generates the model by using the data provided by the user subject having the one authority level among the plurality of authority levels including the third authority level that can share a model generated by using data of the user subject having the third authority level.

9. The information processing apparatus according to claim 1, wherein
the generation unit
generates meta information corresponding to the model according to the data provided by the user subject.

10. The information processing apparatus according to claim 1, further comprising
a transmission unit that transmits the model to a terminal device used by the user subject.

11. The information processing apparatus according to claim 10, further comprising
an acceptance unit that accepts the data from the user subject, wherein
the generation unit generates the model in response to acceptance of the data by the acceptance unit.

12. The information processing apparatus according to claim 11, wherein
the generation unit
generates the model at a timing that the acceptance unit accepts the data, and
the transmission unit
transmits the model to the terminal device at a timing that the generation unit generates the model.

13. The information processing apparatus according to claim 1, wherein
the determination unit
determines information to be provided to one user subject according to a history of using the service by the one user subject.

14. The information processing apparatus according to claim 13, wherein
the determination unit
determines a plurality of models, information of the plurality of models being provided to the one user subject, and
the generation unit
generates list information of the plurality of models determined by the determination unit.

15. The information processing apparatus according to claim 13, wherein
the determination unit
determines a recommended model among a plurality of models, a use of the recommended model being recommended to the one user subject.

16. The information processing apparatus according to claim 1, wherein
the generation unit
generates the model regarding generation of music by using the data provided by the user subject having the one authority level among the plurality of authority levels of the service regarding creation of the content, the content being the music.

17. The information processing apparatus according to claim 16, further comprising
a providing unit that provides a listening service of the music.

18. The information processing apparatus according to claim 17, wherein
the providing unit
provides the listening service of the music generated when the model is used.

19. An information processing method executed by a computer, the method comprising:
generating a model regarding generation of content by using data provided by a user subject of a service regarding creation of the content, the user subject having one authority level among a plurality of authority levels of the service; and
determining a usage mode of the model generated according to the one authority level of the user subject.

20. An information processing program causing a computer to execute:
generating a model regarding generation of content by using data provided by a user subject of a service regarding creation of the content, the user subject having one authority level among a plurality of authority levels of the service; and
determining a usage mode of the model generated according to the one authority level of the user subject.
